(19) United States
(12) Patent Application Publication
(10) Pub. No.: US 2021/0023704 A1
(43) Pub. Date: Jan. 28, 2021

(54) INFORMATION PROCESSING APPARATUS, INFORMATION PROCESSING METHOD, AND ROBOT APPARATUS

(71) Applicant: SONY CORPORATION, TOKYO (JP)

(72) Inventors: NORIKO TOTSUKA, KANAGAWA (JP); HIROAKI OGAWA, CHIBA (JP)

(21) Appl. No.: 17/044,966

(22) PCT Filed: Jan. 31, 2019
(86) PCT No.: PCT/JP2019/003534

§ 371 Date: Oct. 2, 2020

(30) Foreign Application Priority Data
Apr. 10, 2018 (JP) 2018-075768

(51) Int. Cl. B25J 9/16; G10L 15/22; B25J 11/00; B25J 13/00; B25J 13/08; G06Q 30/02

(52) U.S. Cl. CPC B25J 9/1664; B25J 9/163; G10L 15/22; G10L 2015/223; B25J 13/003; B25J 13/089; G06Q 30/0242; B25J 11/0005

(57) ABSTRACT

To provide an information processing apparatus and an information processing method for executing processing for causing an interactive apparatus to actuate an action leading to advertising promotion, and a robot apparatus. An information processing apparatus includes: a determination unit that determines that a trigger according to which an interactive apparatus should actuate an expressive motion leading to advertising promotion has been generated; and a decision unit that decides an expressive motion of the interactive apparatus on the basis of the determined trigger. The determination unit detects a trigger on the basis of a recognition result of a detection signal of a sensor that detects a state of surroundings of the interactive apparatus, and determines an interest level indicated by the trigger. Then, the decision unit decides an expressive motion of the interactive apparatus leading to advertising promotion according to the interest level.

### TECHNICAL FIELD

The technology disclosed in the present specification relates to an information processing apparatus and an information processing method for executing processing for causing an interactive apparatus to actuate a predetermined action, and a robot apparatus.

### BACKGROUND ART

Interactive apparatuses that interact with users, such as robots and voice agents, have become popular in general households. Information provided to the user during interaction or the like by this type of interactive apparatus can include advertisement information from a company having a sponsor contract with the manufacturer of the apparatus, and the like. Here, when an advertising phrase is inserted out of context during a voice interaction with the user, or when an advertising movie is forcibly reproduced before the user watches the content that the user wants to watch, there is a large possibility that the user may have a feeling of dislike and advertising promotion becomes counterproductive, which is a problem.

For example, there has been proposed a robot control apparatus that selects advertisement information on the basis of user information such as preference, or controls the timing of presenting advertisement information to the user on the basis of the result of recognition of an input voice from the user such as “boring” (for example, see Patent Document 1). A robot driven and controlled by this type of robot control apparatus presents advertisement information that matches the preference of the user to the user at a timing that does not disturb the user, and thus it can be expected that the likability of the user for the advertisement is improved. However, unless the user permits the presentation of an advertisement such as utterance of “boring”, the robot cannot present an advertisement, and there is a concern that a sufficient advertising promotion effect cannot be obtained. In addition, it is necessary for the robot control apparatus to accumulate user information in order to judge the preference of the user, but until the sufficient user information is accumulated, there is a possibility that it is difficult to present an effective advertisement.

Furthermore, most of conventional advertising promotion methods use image information such as still images and moving images, and voice information such as announcements. In a case where advertising promotion is to be achieved using various apparatuses, an apparatus that performs advertising promotion does not always have to be equipped with a device such as a display for outputting an image or a speaker for utterance. That is, it is assumed that it is desirable to perform advertising promotion using an apparatus that cannot perform advertising promotion using language information or image information.

### CITATION LIST

### Patent Document

Patent Document 1: Japanese Patent Application Laid-Open No. 2004-302328

### SUMMARY OF THE INVENTION

### Problems to be Solved by the Invention

An object of the technology disclosed in the present specification is to provide an information processing apparatus and an information processing method for executing processing for causing an interactive apparatus to actuate an action leading to advertising promotion, and a robot apparatus.

### Solutions to Problems

The technology disclosed in the present specification has been made in view of the aforementioned problems, and a first aspect thereof is an information processing apparatus including:

a determination unit that determines that a trigger according to which an interactive apparatus should actuate an expressive motion leading to advertising promotion has been generated; and

a decision unit that decides an expressive motion of the interactive apparatus on the basis of the determined trigger.

The determination unit detects a trigger on the basis of a recognition result of a detection signal of a sensor that detects a state of surroundings of the interactive apparatus, and determines an interest level indicated by the trigger. Then, the decision unit decides an expressive motion of the interactive apparatus leading to advertising promotion according to the interest level.

The determination unit determines a trigger on the basis of a recognition result of at least one or both of voice information and image information of surroundings of the interactive apparatus. That is, the determination unit detects, as a trigger, that a predetermined keyword has been uttered on the basis of the voice recognition result, or the determination unit detects, as a trigger, that a predetermined target has been expressed on the basis of the image recognition result.

Furthermore, in a case where the interactive apparatus includes a self-propelled function, the decision unit decides an expressive motion of the interactive apparatus including a movement of the interactive apparatus. For example, the decision unit decides an expressive motion including a movement of the interactive apparatus according to a direction or distance of the trigger.

Furthermore, a second aspect of the technology disclosed in the present specification is an information processing method including:

a determination step of determining that a trigger according to which an interactive apparatus should actuate an expressive motion leading to advertising promotion has been generated; and

a decision step of deciding an expressive motion of the interactive apparatus on the basis of the determined trigger.

Furthermore, a third aspect of the technology disclosed in the present specification is a robot apparatus including:

a sensor;

a drive unit or an output unit;

a recognition unit that recognizes a state of surroundings on the basis of a detection result of the sensor; and

a decision unit that decides an expressive motion leading to advertising promotion using the drive unit or the output unit on the basis of the state recognized by the recognition unit.

### Effects of the Invention

According to the technology disclosed in the present specification, it is possible to provide an information processing apparatus and an information processing method for executing processing for causing an interactive apparatus to actuate an action leading to advertising promotion, and a robot apparatus.

Note that the effects described in the present specification are merely illustrative, and the effects of the present invention are not limited thereto. Furthermore, the present invention may exhibit additional effects in addition to the above effects.

Still other objects, features, and advantages of the technology disclosed in the present specification will become apparent from the following embodiments and more detailed description based on the accompanying drawings.

### BRIEF DESCRIPTION OF DRAWINGS

FIG. 1 is a diagram showing an external configuration example of a robot 1.

FIG. 2 is a diagram showing an internal configuration example of an electric system of the robot 1.

FIG. 3 is a diagram showing a functional configuration example of a main control unit 61.

FIG. 4 is a diagram showing a functional configuration example 1 of an action determination mechanism unit 103.

FIG. 5 is a diagram showing a functional configuration example 2 of the action determination mechanism unit 103.

FIG. 6 is a diagram showing a functional configuration example 3 of the action determination mechanism unit 103.

FIG. 7 is a diagram showing a functional configuration example 4 of the action determination mechanism unit 103.

FIG. 8 is a flowchart showing a processing procedure for performing trigger determination by prioritizing voice data and image data.

FIG. 9 is a diagram showing a functional configuration example 5 of the action determination mechanism unit 103.

### MODE FOR CARRYING OUT THE INVENTION

Embodiments of the technology disclosed in the present specification will be described in detail below with reference to the drawings.

### A. System Configuration

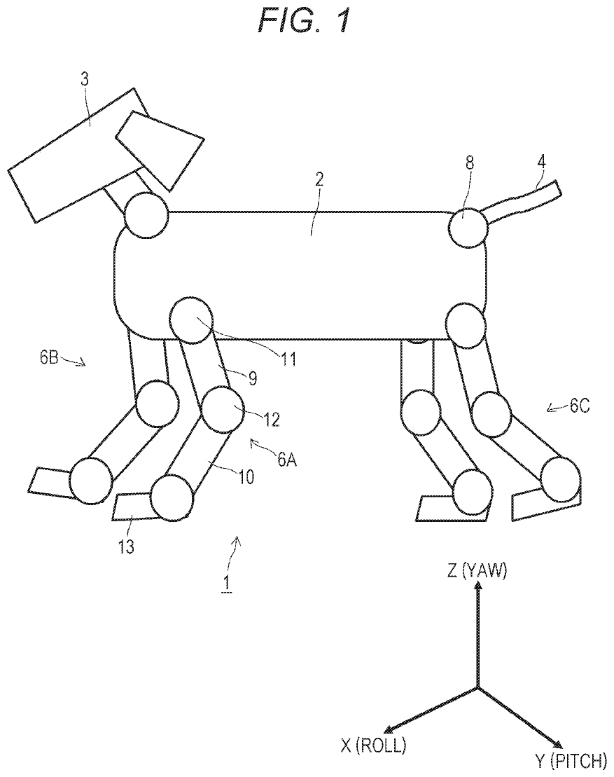

FIG. 1 shows an external configuration example of a robot 1 of a mobile type that performs legged walking with four limbs as an example of an interactive apparatus that interacts with a user. As shown in the drawing, the robot 1 is an articulated robot having the shape or structure of an animal having four limbs, and is designed to imitate the shape or structure of a dog, which is a representative example of a pet animal. Furthermore, the robot 1 can perform various expressive motions in which any one or two or more modals of motion, voice, and image of the four limbs are combined in response to an interaction with the user. Furthermore, FIG. 1 shows respective axes of roll, pitch, and yaw on a robot coordinate system.

The robot 1 includes a trunk unit 2, a head unit 3, a tail 4, and four limbs, i.e., leg units 6A, 6B, 6C, 6D.

The head unit 3 is arranged near a front upper end of the trunk unit 2 via a neck joint 7 having a degree of freedom in respective axis directions of roll, pitch and yaw. Furthermore, the head unit 3 includes a camera (stereo camera) corresponding to the “eyes” of the dog, a microphone corresponding to the “ears” of the dog, a speaker corresponding to the “mouth” of the dog, a touch sensor corresponding to the tactile sensation, and the like. In addition to these, sensors that constitute the five senses of the living body may be included.

The tail 4 is arranged near a rear upper end of the trunk unit 2 via a tail joint 8 having degrees of freedom of roll and pitch axes. The tail 4 may be curved or swingable.

The leg units 6A and 6B constitute left and right front legs, and the leg units 6C and 6D constitute left and right rear legs. Each leg unit 6A, 6B, 6C, 6D includes a combination of a thigh unit 9, a shin unit 10 and a foot unit 13, and is attached to each of the front, rear, left and right corners of the bottom surface of the trunk unit 2. The thigh unit 9 is coupled to each predetermined portion of the trunk unit 2 by a hip joint 11 having degrees of freedom of respective axes of roll, pitch, and yaw. Furthermore, the thigh unit 9 and the shin unit 10 are coupled by a knee joint 12 having degrees of freedom of roll and pitch axes. Furthermore, the shin unit 10 and the foot unit 13 are coupled by an ankle joint having degrees of freedom of roll and pitch axes.

The degree of freedom of joint of the robot 1 is practically provided by driving of an actuator (not shown) such as a motor arranged for each axis. However, the number of degrees of freedom of joint that the robot 1 has is arbitrary, and is not limited to the above-described degree of freedom configuration. Although not described above, the robot 1 may further include a degree of freedom of joint for swinging the left and right ears.

Furthermore, a speaker for voice output is arranged near the “mouth” of the head unit 3, a stereo camera is arranged near the left and right “eyes”, and a microphone for voice input is arranged near at least one of the left or right “ears”.

Note that although a four-legged walking robot is illustrated in FIG. 1, an interactive apparatus that realizes the technology of maintaining energy in the present specification is not limited to a mobile robot that performs legged walking such as two-legged, four-legged, and six-legged, but may be a robot that employs another moving mechanism such as a crawl type or a stationary robot that does not move.

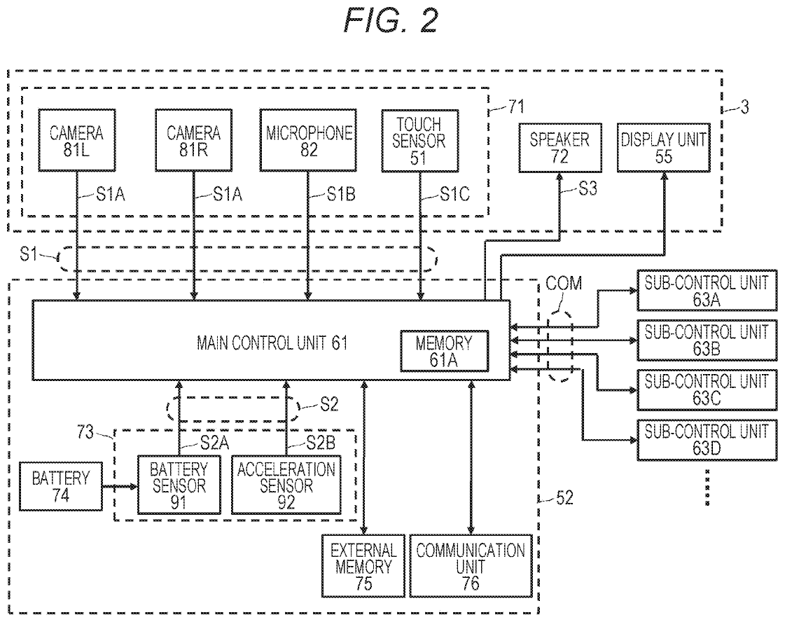

FIG. 2 shows an internal configuration example of an electric system of the robot 1.

In the head unit 3, as an external sensor unit 71, cameras 81L and 81R that function as the left and right “eyes” of the robot 1, a microphone 82 that functions as the “ears”, a touch sensor 51, and the like are arranged in predetermined positions. As the cameras 81L and 81R, a camera including an imaging element such as a complementary metal oxide semiconductor (CMOS), a charge coupled device (CCD), or the like is used.

Note that, although not shown, the external sensor unit 71 may further include other sensors. For example, the external sensor unit 71 may include a sensor capable of measuring or estimating the direction and distance of a predetermined target such as a laser imaging detection and ranging (LIDAR), a time of flights (TOF) sensor, and a laser range sensor. Furthermore, the external sensor unit 71 may include a global positioning system (GPS) sensor, an infrared sensor, a temperature sensor, a humidity sensor, an illuminance sensor, and the like.

Furthermore, in the head unit 3, a speaker 72, a display unit 55, and the like are each arranged as output units in predetermined positions. The speaker 72 outputs a voice and functions as the “mouth”. Furthermore, the display unit 55 displays a state of the robot 1 and a response to the user. Note that the robot 1 may output the information related to advertising promotion using the speaker 72 and the display unit 55.

In a control unit 52, a main control unit 61, a battery 74, an internal sensor unit 73 including a battery sensor 91, an acceleration sensor 92, and the like, an external memory 75, and a communication unit 76 are arranged. The control unit 52 is installed, for example, in the trunk unit 2 of the robot 1.

The cameras 81L and 81R of the external sensor unit 71 capture an image of the surroundings and send the obtained image signal S1A to the main control unit 61. The microphone 82 collects a voice input from the user, and sends the obtained voice signal S1B to the main control unit 61. The input voice given to the robot 1 from the user also includes, for example, various command voices (voice commands) and activation words such as “walk”, “stop”, “raise right hand”, or the like. Note that although only one microphone 82 is depicted in FIG. 2, two or more microphones may be provided like the left and right ears.

Furthermore, the touch sensor 51 of the external sensor unit 71 is arranged, for example, on an upper portion of the head unit 3, detects a pressure exerted by a physical action such as “stroking” or “patting” from the user, and sends the detection result to the main control unit 61 as a pressure detection signal S1C.

The battery sensor 91 of the internal sensor unit 73 detects the energy remaining amount of the battery 74 at every predetermined cycle, and sends the detection result to the main control unit 61 as a battery remaining amount detection signal S2A.

The acceleration sensor 92 detects acceleration of movement of the robot 1 in the three axis directions (x-axis, y-axis, and z-axis) at every predetermined cycle, and sends the detection result to the main control unit 61 as an acceleration detection signal S2B. The acceleration sensor 92 may be, for example, an inertial measurement unit (IMU) equipped with a triaxial gyro, a tridirectional acceleration sensor, and the like.

The external memory 75 stores a program, data, control parameters, and the like, and supplies the program and the data to a memory 61A incorporated in the main control unit 61 as necessary. Furthermore, the external memory 75 receives data and the like from the memory 61A and stores them. Note that the external memory 75 may be configured as a cartridge-type memory card such as an SD card, for example, and may be detachable from the main body of the robot 1 (or the control unit 52).

The communication unit 76 performs data communication with the outside on the basis of a communication method such as Wi-Fi (registered trademark), long term evolution (LTE), or the like. For example, a program such as an application executed by the main control unit 61 and data necessary for executing the program can be acquired from the outside via the communication unit 76. Furthermore, the information necessary for the robot 1 to perform an expressive motion leading to advertising promotion can be set or changed in setting in the robot 1 from an external apparatus via the communication unit 76. Note that, details of the expressive motion leading to advertising promotion will be described later.

The main control unit 61 incorporates the memory 61A. The memory 61A stores a program and data, and the main control unit 61 executes various the program stored in the memory 61A to perform various processing. That is, the main control unit 61 determines the situation around and inside the robot 1, an instruction from the user, the presence or absence of an action from the user, or the like on the basis of the image signal S1A, the voice signal S1B, and the pressure detection signal S1C (hereinafter, these are collectively called external sensor signal S1) supplied from the cameras 81L and 81R, the microphone 82, and the touch sensor 51 of the external sensor unit 71, respectively, and the battery remaining amount detection signal S2A and the acceleration detection signal S2B (hereinafter, these are collectively called internal sensor signal S2) supplied from the battery sensor 91 and the acceleration sensor of the internal sensor unit 73, respectively. Furthermore, the main control unit 61 performs processing (described later) of detecting a target and a keyword that becomes a trigger for actuating an expressive motion that leads to advertising promotion by image-recognition of the image signal S1A and voice-recognition of the voice signal S1B.

Then, the main control unit 61 determines the action of the robot 1 or an expressive motion to be actuated to the user on the basis of the determination result regarding the situation around and inside the robot 1, an instruction from the user, or the presence or absence of an action from the user and a control program stored in advance in the internal memory 61A or various control parameters stored in the external memory 75 loaded at that time or the like, generates a control command based on the determination result, and sends it to each sub-control unit 63A, 63B, . . . . On the basis of the control command supplied from the main control unit 61, the sub-control units 63A, 63B, . . . control driving of an actuator (not shown) that operates each unit including the trunk unit 2, the head unit 3, the leg units 6A, 6B, 6C, 6D, and the like. Therefore, the robot 1 performs actions, for example, swinging the head unit 3 up and down and left and right, raising arm units 6A and 6B of the front legs, walking by alternately driving the front and rear leg units 6A, 6B, 6C, and 6D, and the like.

Furthermore, the main control unit 61 outputs a voice based on a voice signal S3 to the outside by giving a predetermined voice signal S3 to the speaker 72 as necessary, and, for example, when the voice is detected, displays a response to the user such as “who are you” on the display unit 55 on the basis of a display signal S4. Moreover, the main control unit 61 may cause the LED to function as the display unit 55 by outputting a drive signal to an LED, which is not shown, provided at a predetermined position of the head unit 3 and causing the LED to blink. This LED functions as the “eye” in appearance.

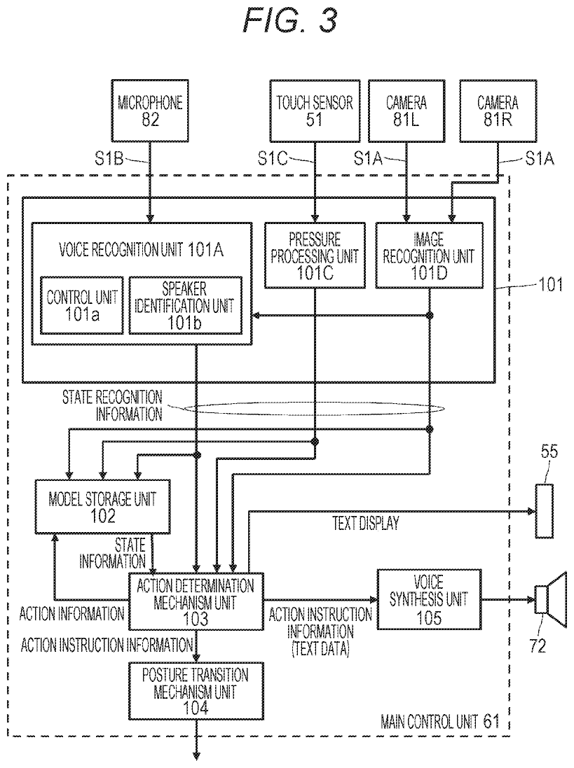

FIG. 3 shows a functional configuration example of the main control unit 61 of FIG. 2. Note that the functional configuration shown in FIG. 3 is realized by the main control unit 61 executing the control program stored in the memory 61A.

The main control unit 61 includes a state recognition information processing unit 101, a model storage unit 102, an action determination mechanism unit 103, a posture transition mechanism unit 104, and a voice synthesis unit 105. The state recognition information processing unit 101 recognizes a specific external state. The model storage unit 102 stores a model of an emotion, instinct, growth state, or the like of the robot 1, which is updated on the basis of the recognition result of the state recognition information processing unit 101, and the like. The action determination mechanism unit 103 determines the action of the robot 1 on the basis of the recognition result of the state recognition information processing unit 101, and the like. The posture transition mechanism unit 104 practically causes the robot 1 to take an action such as an expressive motion with respect to the user on the basis of the determination result of the action determination mechanism unit 103. The voice synthesis unit 105 generates a synthetic voice output as a voice from the speaker 72. Note that the main control unit 61 may further include a functional configuration other than those indicated by reference numbers 101 to 105. Hereinafter, each unit will be described in detail.

A voice signal, an image signal, and a pressure detection signal are constantly input to the state recognition information processing unit 101 from each of the microphone 82, the cameras 81L and 81R, and the touch sensor 51 while the robot 1 is turned on. Then, the state recognition information processing unit 101, on the basis of the voice signal, the image signal, and the pressure detection signal given from the microphone 82, the cameras 81L and 81R, and the touch sensor 51, recognizes a specific external state, a specific action from the user, an instruction from the user, and the like, and constantly outputs state recognition information indicating the recognition result to the model storage unit 102 and the action determination mechanism unit 103.

The state recognition information processing unit 101 has a voice recognition unit 101A, a pressure processing unit 101C, and an image recognition unit 101D.

The voice recognition unit 101A detects the presence or absence of a voice in the voice signal S1B given from the microphone 82, and, when the voice is detected, outputs to the action determination mechanism unit 103 that the voice has been detected. The voice recognition unit 101A includes a control unit 101a that integrally controls input/output of information and voice recognition processing of an input voice signal. Furthermore, the voice recognition unit 101A may further include a speaker identification unit 101b that performs speaker identification on the input voice signal.

The voice recognition unit 101A performs voice recognition, and notifies the model storage unit 102 and the action determination mechanism unit 103 of, for example, an instruction such as “let's play”, “stop”, “raise right hand”, and the like or other voice recognition results as state recognition information. Furthermore, the voice recognition unit 101A performs speaker identification on the voice that is a voice recognition target by the speaker identification unit 101b, and notifies the model storage unit 102 and the action determination mechanism unit 103 of the result as state recognition information. Note that although the example shown in FIGS. 1 to 3 is equipped with only one microphone 82, in a case where a voice can be input from two or more microphones installed in different places, the voice recognition unit 101A may further recognize the position and direction of the sound source.

The pressure processing unit 101C processes the pressure detection signal S1C given from the touch sensor 51. Then, the pressure processing unit 101C, as a result of the processing, for example, when a pressure equal to or higher than a predetermined threshold value and lasting a short period of time is detected, recognizes it as “being hit (scolded)”, and when a pressure less than the predetermined threshold value and lasting a long period of time is detected, recognizes it as “being stroked (praised)”. Then, the pressure processing unit 101C notifies the model storage unit 102 and the action determination mechanism unit 103 of the recognition result as state recognition information.

The image recognition unit 101D performs image recognition processing using the image signal S1A given from the cameras 81L and 81R. Then, the image recognition unit 101D, when, as a result of the processing, for example, “a red round object”, “a plane perpendicular to the ground and having a predetermined height or more”, or the like is detected, notifies the voice recognition unit 101A, the model storage unit 102, and the action determination mechanism unit 103 of the image recognition result such as “there is a ball”, “there is a wall” or detection of a human face, as state recognition information. Furthermore, the image recognition unit 101D may include a user identification function such as face recognition.

The model storage unit 102 stores and manages models such as an emotion model, an instinct model, and a growth model that express the emotion, instinct, and growth state of the robot 1.

Here, the emotion model includes, for example, emotional states (degrees) such as “joy”, “sadness”, “anger”, and “fun”, and each state is indicated by a value in a predetermined range (for example, −1.0 to 1.0, or the like). The model storage unit 102 stores a value representing the state of each emotion, and changes the value on the basis of the state recognition information from the state recognition information processing unit 101, the elapsed time, and the like.

Furthermore, the instinct model includes, for example, desire states (degrees) of instinct such as “appetite”, “sleep desire”, and “exercise desire”, and each state is indicated by a value in a predetermined range. The model storage unit 102 stores a value representing the state of each desire, and changes the value on the basis of the state recognition information from the state recognition information processing unit 101, the elapsed time, and the like.

Furthermore, the growth model includes, for example, growth states (degrees) such as “childhood”, “adolescence”, “maturity”, and “old age”, and each state is indicated by a value in a predetermined range. The model storage unit 102 stores a value representing the state of each growth, and changes the value on the basis of the state recognition information from the state recognition information processing unit 101, the elapsed time, and the like.

The model storage unit 102 sends the emotion, instinct, and growth states indicated by the values of the emotion model, the instinct model, and the growth model to the action determination mechanism unit 103 as state information as described above.

Note that, in addition to the state recognition information supplied from the state recognition information processing unit 101 to the model storage unit 102, the action determination mechanism unit 103 supplies the current or past action of the robot 1, specifically, for example, action information indicating the content of an action such as “walked for a long time”. Accordingly, the model storage unit 102 is configured to generate different state information according to the action of the robot 1 indicated by the action information even when the same state recognition information is given from the state recognition information processing unit 101.

That is, for example, in a case where the robot 1 greeted the user and was stroked by the user on the head, the action information indicating that the robot 1 greeted the user and the state recognition information indicating that the robot 1 was stroked on the head are given to the model storage unit 102, and in this case, the value of the emotion model indicating “joy” is increased in the model storage unit 102. On the other hand, in a case where the robot 1 was stroked on the head during execution of some work, the action information indicating that the work is being executed and the state recognition information indicating that the robot 1 was stroked on the head are given to the model storage unit 102, and in this case, the value of the emotion model indicating “joy” is not changed in the model storage unit 102.

In this way, the model storage unit 102 sets the value of the emotion model by referring to not only the state recognition information but also the action information indicating the current or past action of the robot 1. Therefore, for example, it is possible to prevent generation of an unnatural emotional change that increases the value of the emotion model indicating “joy” when the user strokes the robot 1 on its head with the intention of mischief while some task is being executed.

Furthermore, the model storage unit 102 can individually have the above emotion model for each user on the basis of the user identification result provided by the voice recognition unit 101A or the image recognition unit 101D. For this reason, in the same robot 1, a “joy” action executed to a first user is different from a “joy” action executed to a second user. Accordingly, the model storage unit 102 can generate various actions according to the individual user by sending the state information corresponding to the user identification result to the action determination mechanism unit 103. Similarly, the robot 1 may perform different expressive motions that lead to advertising promotion for each user.

Note that the model storage unit 102 is configured to increase or decrease the values of the instinct model and the growth model on the basis of the state recognition information and the action information similar to the case of the emotion model. Furthermore, the model storage unit 102 is configured to increase or decrease the values of the emotion model, the instinct model, and the growth model on the basis of also the values of another model.

The action determination mechanism unit 103 determines a next action of the robot 1 on the basis of the state recognition information output from the state recognition information processing unit 101, the state information output from the model storage unit 102, the elapsed time, and the like. Here, in a case where the determined action content does not require voice recognition processing or image recognition processing such as “perform dancing”, the content of the action is sent to the posture transition mechanism unit 104 as action instruction information.

The action determination mechanism unit 103 manages a finite automaton that associates the actions that the robot 1 can take with the states, as an action model that defines the actions of the robot 1. Then, the action determination mechanism unit 103 transitions the state in the finite automaton, which is the action model, on the basis of the state recognition information from the state recognition information processing unit 101, the value of the emotion model, the instinct model, or the growth model of the model storage unit 102, the elapsed time, and the like, and determines the action corresponding to the state after the transition as the action to be taken next.

Here, the action determination mechanism unit 103 transitions the state when it detects that there was a predetermined trigger. That is, the action determination mechanism unit 103 transitions the state when, for example, the time during which the action corresponding to the current state is executed reaches a predetermined time or when specific state recognition information is received, when the emotion indicated by the state information supplied from the model storage unit 102, or the value of instinct or growth becomes equal to or less than or equal to or more than a predetermined threshold value, for example.

Furthermore, as described above, the action determination mechanism unit 103 transitions the state in the action model on the basis of not only the state recognition information from the state recognition information processing unit 101 but also the values of the emotion model, the instinct model, the growth model in the model storage unit 102, and the like. Therefore, even when the same state recognition information is input to the action determination mechanism unit 103, depending on the value (state information) of the emotion model, the instinct model, and the growth model, the transition destination of the state determined by the action determination mechanism unit 103 will be different.

Furthermore, in addition to the action instruction information for operating the head, the four limbs, and the like of the robot 1, the action determination mechanism unit 103 also generates action instruction information for causing the robot 1 to speak. The action instruction information that causes the robot 1 to speak is supplied to the voice synthesis unit 105. The action instruction information supplied to the voice synthesis unit 105 includes text data or the like corresponding to the synthetic voice generated by the voice synthesis unit 105. Then, when the voice synthesis unit 105 receives the action instruction information from the action determination mechanism unit 103, the voice synthesis unit 105 generates a synthetic voice on the basis of the text data included in the action instruction information, and supplies it to the speaker 72 to cause the speaker 72 to output it.

Furthermore, the action determination mechanism unit 103 causes the display unit 55 to text-display a word, as a prompt, that corresponds to the utterance or a substitute for the utterance when the utterance is not made. For example, when a voice is detected and the robot 1 turns around, a text such as “Who?” or “What?” can be displayed as a prompt on the display unit 55 or can be generated from the speaker 72.

Furthermore, in the present embodiment, the action determination mechanism unit 103 inputs the image recognition result and the voice recognition result from the state recognition information processing unit 101, and performs processing such as determination of a target or keyword that becomes a trigger for actuating an expressive motion leading to advertising promotion or determination of an expressive motion based on the determination result. The details will be described later.

Note that a part or whole of the functional configuration indicated by reference numbers 101 to 105 (the part surrounded by the dotted line in FIG. 3) may be realized not inside the main control unit 61 but outside the robot 1 (including the cloud). For example, a sensor signal from the cameras 81L/R, the microphone 82, or the like is transmitted to the cloud by the communication unit 76, a part or whole of the processing such as the above-described recognition processing or action determination is executed on the cloud side, the processing result in the cloud is received by the communication unit 76, and output on the robot 1 or joint drive is performed.

### B. Advertising Promotion by the Robot

The robot 1 according to the present embodiment interacts with the user as an interactive apparatus, and uses the movements of the head and the four limbs to perform various expressive motions. Furthermore, the robot 1 also presents advertisement information to the user who is in conversation or in the vicinity. The advertisement information also includes, for example, advertisement information from a company that has a sponsor contract with the manufacturer of the robot 1, and the like. An application that performs the processing of presenting advertisement information or the content of the advertisement information may be stored in advance in an internal memory such as the memory 61A, or may be supplied from the outside at any time by using the replaceable external memory 75. Alternatively, the latest application or advertisement content may be downloaded from the site of a contract company via the communication unit 76 via a wide area network such as the Internet.

Here, there is a problem that, when the robot 1 performs an expressive motion for advertising promotion without an interaction with the user or out of context, or forcibly or abruptly, there is a large possibility that the user may have a feeling of dislike and advertising promotion becomes counterproductive.

A technology that presents an advertisement that matches the interests or concerns of the user has been proposed. However, in order to properly determine the preference of the user, it is necessary to accumulate sufficient user information, and there is a problem that until the sufficient user information is accumulated, it is difficult to present an effective advertisement.

Therefore, in the present specification, a technology in which the robot 1 uses a normally output expressive motion to perform advertising promotion such that a natural and non-pushy advertising promotion that the user hardly has a feeling of dislike is achieved is proposed below. Note that also with other types of interactive apparatuses such as voice agents, instead of the robot 1, by using a normally output expressive motion, it is possible to similarly achieve advertising promotion that the user hardly has a feeling of dislike.

When the robot 1 shows a specific reaction to a product or service targeted for the advertisement within the range of the normally output expressive motion, it will lead to advertising promotion and it will be natural and non-pushy such that the user will hardly have a feeling of dislike.

### B-1. Expressive Motion of the Robot Leading to Advertising Promotion

The expressive motion of the robot 1 that leads to advertising promotion is actuated on the basis of the detection result of the external sensor unit 71 or the result of recognition of a specific external state such as a voice or an image by the state recognition information processing unit 101.

For example, in a case where a specific word or phrase that is a keyword is recognized from the utterance of the user who is talking or from a television commercial or other ambient sounds, the expressive motion that is actuated from the voice recognition result includes that the robot 1 faces in a direction from which that keyword is heard or takes an action of approaching. The keyword mentioned here may be, for example, the name of a company that has made a sponsorship contract, a specific product name, a catchphrase, a melody, or the like provided by the company. Furthermore, the model storage unit 102 may add the value of the emotional model “joy” or “fun” on the basis of the number of times such a keyword is heard (or voice-recognized) to realize an expressive motion in which the robot 1 becomes in a good mood by listening the keyword many times.

Furthermore, the expressive motion actuated from the image recognition result includes actions that, in a case where the robot 1 recognizes a target object or an object that is associated with the target under the environment where the robot 1 is with the user, the robot 1 runs up to (actively approaches) the target, the robot 1 does not leave the place, the robot 1 makes an envious expression when seeing a person holding a target thing, and the robot 1 becomes very happy when the target is given. The target mentioned here may be, for example, a product provided by a company that has a sponsor contract, a product poster or signboard, a product logo, a commercial image of a product or a company, and the like. Furthermore, the model storage unit 102 may add the value of the emotional model “joy” or “fun” on the basis of the number of times such a target is found (or image-recognized) to realize an expressive motion in which the robot 1 becomes in a good mood by seeing the target many times.

Here, a specific example in which a dog-shaped robot 1 uses an ordinary expressive motion to perform advertising promotion of an ice cream store having a sponsor contract will be introduced. When the robot 1 image-recognizes the advertisement of the newspaper that the user reads and finds the logo of the ice cream store, the robot 1 stares at the logo. Furthermore, an example can be given in which when an ice cream store commercial is played while the robot 1 watches a television program in the living room with the user, the robot 1 runs up to the television screen. Moreover, when an ice cream store is found while the robot 1 takes a walk with the user, the robot 1 wants to enter the store or runs up to the front of the store and does not want to leave.

### B-2. Method of Setting Advertisement Information

Information associated with a keyword or target that causes the robot 1 to actuate an expressive motion that leads to advertising promotion may be set in advance (for example, before shipping of the robot 1), for example, in the internal memory unit 61A of the main control unit 61 or may be updated online from a predetermined server site or the like via the communication unit 76. In the latter case, the robot 1 does not have to permanently continue advertising a specific product or service, and can switch to advertising promotion of a new product or service. The period of time for advertising and promoting one product or service is assumed to be relatively long period such as weeks to months.

Furthermore, it is also possible to control a target or a keyword for causing the robot 1 to actuate an expressive motion leading to advertising promotion. In the above example of advertising promotion of the ice cream store, the robot 1 sensitively respond to a newly set keyword or target when a proper noun such as a brand name, a flavor name (product name) of an ice cream or a brand logo is set to as a keyword or target, which leads to making the brand and the new product known. Alternatively, in a case where the habit of eating ice cream is to be spread in the first place, it is only required to avoid proper nouns such as product names, images unique to specific products, or the like, set common nouns such as “ice cream” and “snack” or a general ice cream image as a keyword or target.

Even in a case where the same product or service is advertised and promoted, the effect of the advertising promotion can be improved or adapted to the user by changing the target or the keyword. For example, the advertising promotion can be performed so as to match the profile information of the user such as age, sex, hobbies and occupation of the user.

The designer of the robot 1 or an advertiser such as a company that has a sponsor contract are only required to determine a keyword or a target to which the robot 1 responds on the basis of its own advertisement policy. Furthermore, the advertiser may also determine a specific expressive motion that the robot 1 actuates in response to a keyword or a target on the basis of its own advertisement policy or the like. An advertiser such as a company that has a sponsorship contract can set and change the setting of the information associated with advertising promotion, such as keywords and targets that lead to advertising promotion, and expressive motions actuated by the robot 1 in response to the keywords and targets, in the robot 1 from an external apparatus via the communication unit 76.

For example, a plurality of keywords or targets to which the robot 1 should respond is set, and an interest level is assigned to each keyword or target. Then, when the robot 1 recognizes the keyword or the target by voice or image recognition processing, the robot 1 actuates an expressive motion leading to advertising promotion according to a corresponding interest level.

Specifically, five levels of interest level are defined, and the interest level is assigned to each keyword or target that leads to advertising promotion. For example, the lowest level 1 is assigned to words of common nouns such as “ice cream” and images of common ice cream, and the intermediate level 3 is assigned to words and images that are associated with advertiser brands and products. Furthermore, the highest level 5 is assigned to the words of proper nouns such as brand names and product names of the advertiser, and images of stores or specific products of the advertiser. For example, an advertiser such as a company with a sponsor contract can define an event such as a keyword or a target that becomes a trigger for actuating an expressive motion that leads to advertising promotion, and set an interest level for each trigger. The correspondence relationship between the trigger and the interest level may be set in advance in the robot 1, or may be set or changed in setting in the robot 1 by the advertiser or the like via the communication unit 76.

Furthermore, the expressive motion that the robot 1 actuates is also defined for each interest level. For example, at the lowest level 1, the tail 4 is wagged, and at the intermediate level 3, the trunk unit 2 is turned back (toward the sound source in which the keyword is uttered or to the found target) and the tail 4 is wagged. Furthermore, at the highest level 5, the robot 1 runs up (toward the sound source in which the keyword is uttered or to the found target) while wagging the tail 4. Table 1 below shows an example of the correspondence relationship between the interest level and the expressive motion leading to advertising promotion. It will be appreciated that all of the expressive motions listed in Table 1 are within the range of motions that the robot 1 normally outputs, and it is possible to realize advertising promotion that the user hardly has a feeling of dislike and does not feel pushiness.

TABLE 1

| INTEREST | |
|---|---|
| LEVEL | EXPRESSIVE MOTION |
| 1 | FACING IN DIRECTION FROM WHICH KEYWORD |
| | IS HEARD |
| 2 | ACTION OF 1 + WAGGING TAIL SLOWLY |
| 3 | ACTION OF 1 + WAGGING TAIL VIOLENTLY |
| 4 | ACTION OF 2 + WALKING TOWARD THAT |
| | DIRECTION |
| 5 | ACTION OF 3 + RUNNING UP TOWARD THAT |
| | DIRECTION |

For example, the designer of the robot 1 can define the correspondence relationship between the interest level and the expressive motion of the robot 1 as shown in Table 1 above. Then, the data of such a facing relationship is set inside in advance, and then the robot 1 is shipped. Of course, the advertiser or the like may be allowed to change the correspondence relationship between the interest level and the expressive motion set in the robot 1 via the communication unit 76.

The action determination mechanism unit 103 determines whether or not an external state such as an image or a voice recognized by the state recognition information processing unit 101 is a trigger for the robot 1 to actuate an expressive motion leading to advertising promotion. For example, it is determined whether or not text data voice-recognized by the voice recognition unit 101A corresponds to a keyword serving as a trigger, and the interest level thereof is calculated. Furthermore, the action determination mechanism unit 103 determines whether or not an object image-recognized by the image recognition unit 101D corresponds to a target serving as a trigger, and the interest level is calculated. Then, the action determination mechanism unit 103 determines the action of the robot 1 for actuating the corresponding expressive motion on the basis of the interest level of the recognized trigger.

### B-3. Configuration Example 1

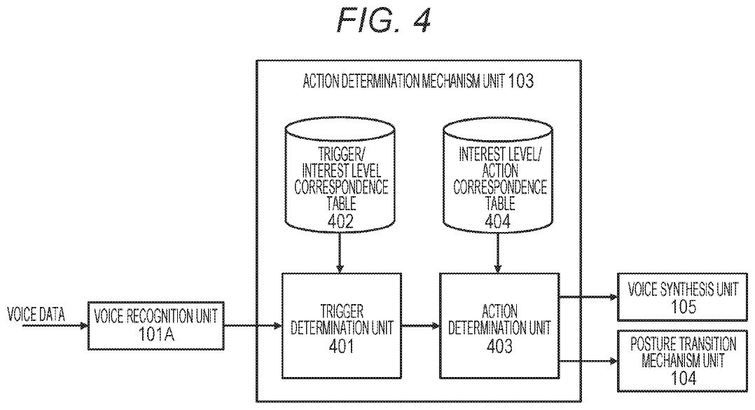

FIG. 4 shows a functional configuration example of the action determination mechanism unit 103 for the robot 1 to actuate an expressive motion leading to advertising promotion on the basis of the voice recognition result.

The illustrated action determination mechanism unit 103 includes a trigger determination unit 401, a trigger/interest level correspondence table 402, an action determination unit 403, and an interest level/action correspondence table 404, and, on the basis of the voice recognition result by the voice recognition unit 101A, outputs the action of the robot 1 for actuating an expressive motion leading to the advertising promotion.

The trigger determination unit 401 extracts a keyword that leads to advertising promotion on the basis of the voice recognition result. The trigger/interest level correspondence table 402 shows the correspondence relationship between keywords that are triggers for actuating an expressive motion leading to advertising promotion and interest levels assigned to the respective keywords. For example, an advertiser such as a company that has a sponsor contract selects a keyword that leads to advertising promotion, assigns an interest level to each keyword, and sets it in the trigger/interest level correspondence table 402. For example, the trigger/interest level correspondence table 402 in the action determination mechanism unit 103 can be set or changed in setting from the outside via the communication unit 76. Table 2 below shows an example of the trigger/interest level correspondence table 402.

TABLE 2

| | INTEREST |
|---|---|
| ACTION ACTUATION TRIGGER | LEVEL |
| VOICE RECOGNITION RESULT INCLUDES | 1 |
| “SNACK”, “SWEETS” | |
| VOICE RECOGNITION RESULT INCLUDES | 2 |
| “ICE CREAM” | |
| VOICE RECOGNITION RESULT INCLUDES | 3 |
| BRAND NAME OF ADVERTISER | |

When text data voice-recognized by the voice recognition unit 101A is successively input, the trigger determination unit 401 checks which action actuation trigger listed in the trigger/interest level correspondence table 402 the text data matches. Then, when the text data matches any of the action actuation triggers, the trigger determination unit 401 acquires the interest level assigned to the action actuation trigger from the corresponding entry of the trigger/interest level correspondence table 402 and outputs the interest level to the action determination unit 403 in the subsequent stage. Note that in a case where a plurality of action actuation triggers matches the input text data, the trigger determination unit 401 adopts the one with the highest interest level.

The interest level/action correspondence table 404 shows the correspondence relationship between the interest level and the expressive motion leading to advertising promotion. For example, the robot 1 having the interest level/action correspondence table 404 defined by the designer of the robot 1 set in advance is shipped. Of course, the advertiser or the like may be allowed to change the setting content of the interest level/action correspondence table 404 via the communication unit 76. Table 3 below shows an example of the interest level/action correspondence table 404. It will be appreciated that all of the action contents listed in Table 3 are within the range of expressive motion that the robot 1 normally outputs, and it is possible to realize advertising promotion that the user hardly has a feeling of dislike and does not feel pushiness.

TABLE 3

| INTEREST LEVEL | ACTION CONTENT |
|---|---|
| 1 | RAISING EARS A LITTLE |
| 2 | ACTION OF 1 + WAGGING TAIL SLOWLY |
| 3 | ACTION OF 1 + WAGGING TAIL VIOLENTLY |

When the action determination unit 403 specifies an expressive motion corresponding to the interest level of the trigger determined by the trigger determination unit 401 with reference to the interest level/action correspondence table 404, the action determination unit 403 determines an action of the robot 1 for actuating the expressive motion and outputs it to the posture transition mechanism unit 104, the voice synthesis unit 105, and the like.

Note that since the action determination mechanism unit 103 has a similar functional configuration even in a case where the robot 1 actuates the expressive motion leading to advertising promotion on the basis of the image recognition result instead of the voice recognition result, detailed description is omitted in the present specification.

In the configuration example of the action determination mechanism unit 103 shown in FIG. 4, for example, when a commercial of an ice cream store is heard while the robot 1 watches a television program in the living room with the user, this matches the interest level 2. Therefore, the robot 1 actuates an action of raising the ears a little and wagging the tail 4 violently. When the user who sees such action of the robot 1 pays attention to the commercial of the ice cream store on the television, it leads to advertising promotion of the ice cream store.

Note that in the trigger/interest level correspondence table 402 and the interest level/action correspondence table 404, the degree of interest of the user is indicated in a multidimensional scale such as “long-lasting degree of interest” or “excitement degree” instead of the one-dimensional interest level in multiple stages, and a correspondence table that defines the expressive motion corresponding to each degree of interest is prepared. Thus, it is possible to cause the robot 1 to actuate a rich expressive motion. Furthermore, the action may be determined using a correspondence table in which the “action actuation trigger” and the “expressive motion (action)” are directly associated with each other without depending on the interest level.

### B-4. Configuration Example 2

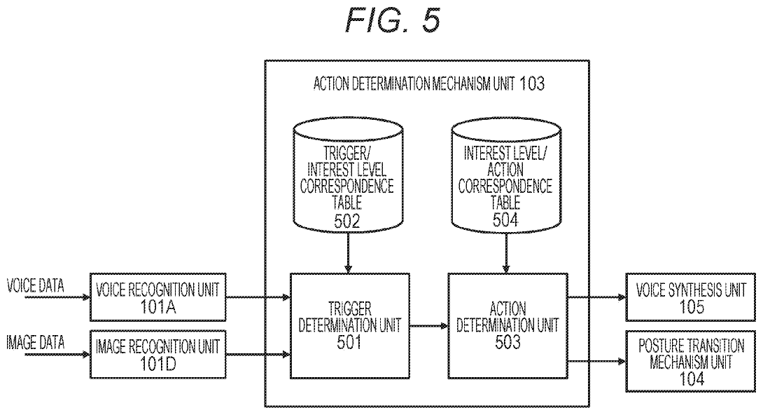

FIG. 5 shows a functional configuration example of the action determination mechanism unit 103 for the robot 1 to actuate an expressive motion leading to advertising promotion on the basis of the image recognition result and the voice recognition result.

The illustrated action determination mechanism unit 103 includes a trigger determination unit 501, a trigger/interest level correspondence table 502, an action determination unit 503, and an interest level/action correspondence table 504, and, on the basis of the voice recognition result by the voice recognition unit 101A and the image recognition result by the image recognition unit 101D, outputs the action of the robot 1 for actuating an expressive motion leading to the advertising promotion.

The trigger determination unit 501 extracts a keyword that leads to advertising promotion on the basis of the voice recognition result and extracts a target that leads to advertising promotion on the basis of the image recognition result. The trigger/interest level correspondence table 502 shows the correspondence relationship between a combination of keywords and targets that are triggers for actuating an expressive motion leading to advertising promotion and interest levels assigned to each of the combination of the keywords and the targets. For example, an advertiser such as a company that has a sponsor contract selects a combination of a keyword and a target that lead to advertising promotion, assigns an interest level to each combination of the keyword and the target, and sets it in the trigger/interest level correspondence table 502. For example, the trigger/interest level correspondence table 502 in the action determination mechanism unit 103 can be set or changed in setting from the outside via the communication unit 76. Table 4 below shows an example of the trigger/interest level correspondence table 502.

TABLE 4

| | INTEREST |
|---|---|
| ACTION ACTUATION TRIGGER | LEVEL |
| VOICE RECOGNITION RESULT INCLUDES | 1 |
| BRAND NAME OF ADVERTISER | |
| IMAGE RECOGNITION RESULT INCLUDES | 2 |
| BRAND LOGO OF ADVERTISER | |
| VOICE RECOGNITION RESULT INCLUDES | 3 |
| BRAND NAME OF ADVERTISER AND IMAGE | |
| RECOGNITION RESULT INCLUDES BRAND LOGO | |

When text data voice-recognized by the voice recognition unit 101A and a target image-recognized by the image recognition unit 101D are successively input, the trigger determination unit 501 checks which action actuation trigger listed in the trigger/interest level correspondence table 502 the combination of the text data and the target matches. Then, when the combination of the text data and the target matches any of the action actuation triggers, the trigger determination unit 501 acquires the interest level assigned to the action actuation trigger from the corresponding entry of the trigger/interest level correspondence table 502 and outputs the interest level to the action determination unit 503 in the subsequent stage. Note that in a case where a plurality of action actuation triggers matches the input text data and target, the trigger determination unit 501 adopts the one with the highest interest level.

The interest level/action correspondence table 504 shows the correspondence relationship between the interest level and the expressive motion leading to advertising promotion. For example, the robot 1 having the interest level/action correspondence table 504 defined by the designer of the robot 1 set in advance is shipped. Of course, the advertiser or the like may be allowed to change the setting content of the interest level/action correspondence table 504 via the communication unit 76. For example, the same interest level/action correspondence table 504 as in Table 3 above may be used.

When the action determination unit 503 specifies an expressive motion corresponding to the interest level of the trigger determined by the trigger determination unit 501 with reference to the interest level/action correspondence table 504, the action determination unit 503 determines an action of the robot 1 for actuating the expressive motion and outputs it to the posture transition mechanism unit 104, the voice synthesis unit 105, and the like.

In the configuration example of the action determination mechanism unit 103 shown in FIG. 5, for example, when a commercial of an ice cream store is heard while the robot 1 watches a television program in the living room with the user, this matches the interest level 1. Therefore, the robot 1 actuates an action of raising the ears a little. When a logo of the ice cream store is found as the robot 1 image-recognizes advertisement on newspaper the user is reading, this matches the interest level 2. Therefore, the robot 1 actuates an action of raising the ears a little and wagging the tail 4 slowly. When the user who sees such action of the robot 1 pays attention to the commercial of the ice cream store on the television or stares at an advertisement section on newspaper the user is reading, it leads to advertising promotion of the ice cream store.

Note that in the configuration example shown in FIG. 5, although the modal used for input to the action determination mechanism unit 103 is two types: voice data and image data, three or more types of modal including other than the above may be used to determine an expressive motion of the robot 1.

### B-5. Configuration Example 3

The action determination mechanism units 103 shown in FIGS. 4 and 5 both actuates a motion that the robot 1 can express on the spot without moving, such as motions of the tail 4 and ears. In the case of the robot 1 provided with a moving means (or a self-propelled function) such as legs, it is also possible to actuate a motion including movement of the main body of the robot 1 as an expressive motion leading to advertising promotion.

As shown in FIGS. 2 to 3, in the case of the robot 1 equipped with a stereo camera, the direction and distance information of the target can be extracted on the basis of the image recognition result by the image recognition unit 101D. Furthermore, in a case where the robot 1 is equipped with a plurality of microphones 82, it is possible to estimate the direction and distance of the sound source on the basis of the voice data of a plurality of channels. Moreover, the robot 1 may be provided with a sensor capable of measuring or estimating the direction and distance such as a LIDAR, a TOF sensor, or a laser range sensor so as to estimate the direction and distance to the sound source of the target or the keyword. Then, in such a case, it is possible to utilize the self-propelled function of the robot 1 to actuate the expressive motion according to the direction and the distance to the sound source of the target or the keyword, which leads to advertising promotion.

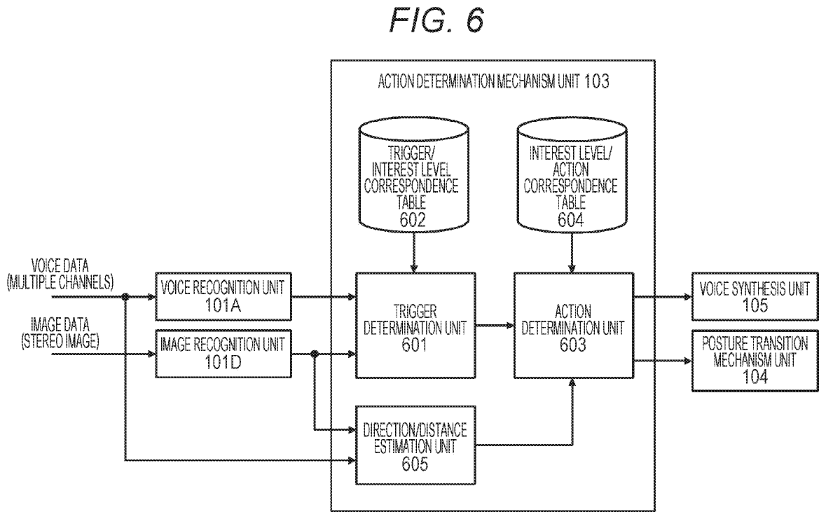

FIG. 6 shows a functional configuration example of the action determination mechanism unit 103 for the robot 1 to actuate an expressive motion leading to advertising promotion by using the direction and distance to the sound source of the target or the keyword.

The illustrated action determination mechanism unit 103 includes a trigger determination unit 601, a trigger/interest level correspondence table 602, an action determination unit 603, an interest level/action correspondence table 604, and a direction/distance estimation unit 605. Moreover, the action determination mechanism unit 103 outputs an action of the robot 1 to actuate an expressive motion leading to advertising promotion by using the sound source of the keyword or the direction and distance to the target estimated by the direction/distance estimation unit 605.

The trigger determination unit 601 extracts a keyword that leads to advertising promotion on the basis of the voice recognition result and extracts a target that leads to advertising promotion on the basis of the image recognition result. The trigger/interest level correspondence table 602 shows the correspondence relationship between a combination of keywords and targets that are triggers for actuating an expressive motion leading to advertising promotion and interest levels assigned to each of the combination of the keywords and the targets. For example, an advertiser such as a company that has a sponsor contract selects a combination of a keyword and a target that lead to advertising promotion, assigns an interest level to each combination of the keyword and the target, and sets it in the trigger/interest level correspondence table 602. For example, the trigger/interest level correspondence table 602 in the action determination mechanism unit 103 can be set or changed in setting from the outside via the communication unit 76. Table 5 below shows an example of the trigger/interest level correspondence table 602.

TABLE 5

| | INTEREST |
|---|---|
| ACTION ACTUATION TRIGGER | LEVEL |
| VOICE RECOGNITION RESULT INCLUDES | 1 |
| “SNACK” OR “SWEETS” | |
| VOICE RECOGNITION RESULT INCLUDES | 2 |
| “ICE CREAM” | |
| VOICE RECOGNITION RESULT INCLUDES | 3 |
| BRAND NAME OF ADVERTISER | |
| IMAGE RECOGNITION RESULT INCLUDES | 4 |
| BRAND LOGO OF ADVERTISER | |
| VOICE RECOGNITION RESULT INCLUDES | 5 |
| BRAND NAME OF ADVERTISER AND IMAGE | |
| RECOGNITION RESULT INCLUDES BRAND LOGO | |

When text data voice-recognized by the voice recognition unit 101A and a target image-recognized by the image recognition unit 101D are successively input, the trigger determination unit 601 checks which action actuation trigger listed in the trigger/interest level correspondence table 602 the combination of the text data and the target matches. Then, when the combination of the text data and the target matches any of the action actuation triggers, the trigger determination unit 601 acquires the interest level assigned to the action actuation trigger from the corresponding entry of the trigger/interest level correspondence table 602 and outputs the interest level to the action determination unit 603 in the subsequent stage. Note that in a case where a plurality of action actuation triggers matches the input text data and target, the trigger determination unit 601 adopts the one with the highest interest level.

The direction/distance estimation unit 605 inputs voice data of a plurality of channels, which is the same as that input to the voice recognition unit 101A, and estimates the direction and distance of the sound source of the keyword. The sound source of the keyword mentioned here is a speaker such as a user who interacts with the robot 1, but it may be a device such as a television that plays a commercial image of an advertiser such as a company that has a sponsor contract. Note that the functional portion of the direction/distance estimation unit 605 that estimates the direction and distance of the sound source may be arranged in the preceding stage of the voice recognition unit 101A or in the voice recognition unit 101A.

Furthermore, the direction/distance estimation unit 605 inputs the image recognition result obtained by recognizing the image of the stereo camera by the image recognition unit 101D, and estimates the direction and distance of the target. The target mentioned here is an object of a television receiver that shows, for example, a product provided by a company that has a sponsor contract, a product poster or signboard, a product logo, a commercial image of a product or a company, and the like. Note that the functional portion of the direction/distance estimation unit 605 that estimates the direction and distance of the target included in the image data may be arranged in the subsequent stage of the image recognition unit 101D or in the image recognition unit 101D.

However, the direction/distance estimation unit 606 may estimate the direction and distance of the target by using only one of the voice data and the image data, or may estimate the direction and distance of the target by using both the voice data and the image data simultaneously.

Note that the direction/distance estimation unit 605 can also be configured using a LIDAR, a TOF sensor, a laser range sensor, or the like, that the robot 1 includes as the external sensor unit 71, instead of a plurality of microphones or stereo cameras.

The interest level/action correspondence table 604 shows the correspondence relationship between the distance from the robot 1 to the sound source of the keyword or the target and the expressive motion leading to advertising promotion for each interest level. For example, the robot 1 having the interest level/action correspondence table 604 defined by the designer of the robot 1 set in advance is shipped. Of course, the advertiser or the like may be allowed to change the setting content of the interest level/action correspondence table 604 via the communication unit 76. Table 6 below shows an example of the interest level/action correspondence table 604. It will be appreciated that all of the action contents listed in Table 6 are within the range of expressive motion that the robot 1 normally outputs, and it is possible to realize advertising promotion that the user hardly has a feeling of dislike and does not feel pushiness.

TABLE 6

| INTEREST | | |
|---|---|---|
| LEVEL | DISTANCE | ACTION CONTENT |
| 1 | — | RAISING EARS A LITTLE |
| 2 | — | ACTION OF 1 + WAGGING |
| | | TAIL SLOWLY |
| 3 | — | ACTION OF 1 + WAGGING |
| | | TAIL VIOLENTLY |
| 4 | LESS THAN 2 m | ACTION OF 2 + SPINNING |
| | | IN CIRCLES ON THE SPOT |
| | 2 m OR MORE | ACTION OF 2 + WALKING |
| | | TOWARD OBJECT OR SPEAKER |
| 5 | LESS THAN 2 m | ACTION OF 2 + JUMPING |
| | | ON THE SPOT |
| | 2 m OR MORE | ACTION OF 3 + RUNNING |
| | | TOWARD OBJECT OR SPEAKER |

When the action determination unit 603 specifies the interest level of the trigger determined by the trigger determination unit 601 and an expressive motion corresponding to the distance and direction to the object or speaker estimated by the direction/distance estimation unit 605 with reference to the interest level/action correspondence table 604, the action determination unit 603 determines an action of the robot 1 for actuating the expressive motion and outputs it to the posture transition mechanism unit 104, the voice synthesis unit 105, and the like.

According to the configuration example of the action determination mechanism unit 103 shown in FIG. 6, for example, when a commercial of an ice cream store is heard while the robot 1 watches a television program four meters away and a logo of the ice cream store displayed on the screen of the television is found, this matches the interest level 5, and the distance from the sound source and screen of the television that is a trigger is two meters or more. Therefore, the robot 1 actuates an action of raising the ears a little and wagging the tail 4 violently and runs toward the television receiver. When the user who sees such action of the robot 1 pays attention to the commercial image of the ice cream store on the television, it leads to advertising promotion of the ice cream store.

Note that the interest level/action correspondence table 604 shown in Table 6 uses the direction/distance information of the trigger, while the trigger/interest level correspondence table 602 shown in Table 5 does not use the direction/distance information of the trigger, but may use a trigger/interest level correspondence table in which direction/distance information is an action actuation trigger.

### B-6. Configuration Example 4

In a case where the robot 1 further includes a function to acquire the current position information of the main body, e.g., GPS, in addition to voice-recognized keywords and image-recognized targets, the current position can be further used to actuate an expressive motion leading to advertising promotion. For example, it is possible to assign an interest level according to the distance from the current position of the robot 1 to a destination, or to cause the robot 1 to actuate an expressive motion according to the distance to the destination.

Specifically, the destination mentioned here is a store operated by an advertiser such as a company that has a sponsor contract. The current position of the robot 1 can be compared with the position of a store operated by an advertiser such as a company that has a sponsor contract, which is obtained from map information or the like, and an interest level can be assigned according to the distance to the nearest store. For example, in an area within a predetermined distance to the nearest store, it is assumed that the effect of advertising promotion is higher than that obtained when only hearing an uttered keyword or seeing a target image, and therefore a higher interest level may be assigned.

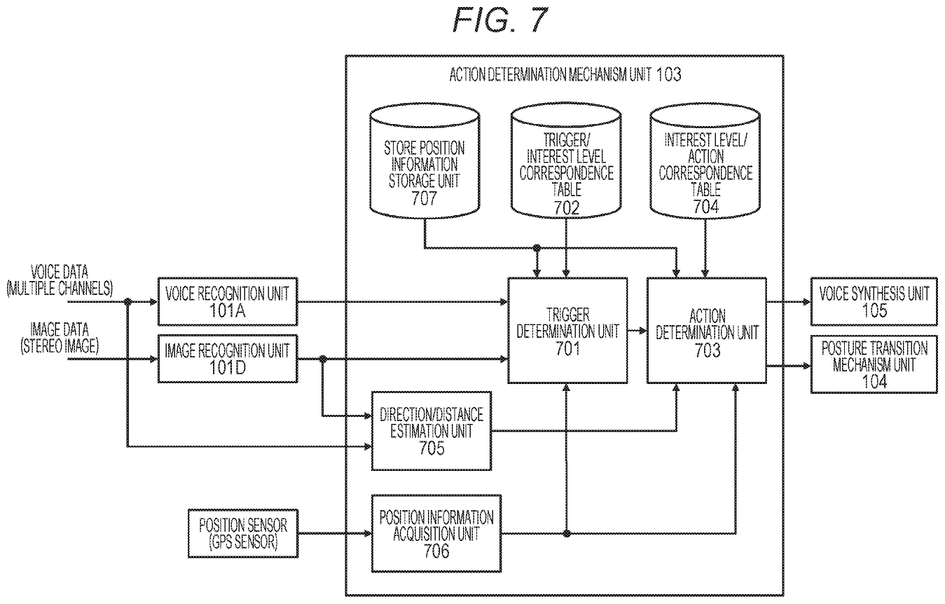

FIG. 7 shows a functional configuration example of the action determination mechanism unit 103 for the robot 1 to actuate an expressive motion leading to advertising promotion further using information of the current position.

The illustrated action determination mechanism unit 103 includes a trigger determination unit 701, a trigger/interest level correspondence table 702, an action determination unit 703, an interest level/action correspondence table 704, a direction/distance estimation unit 705, a position information acquisition unit 706, and a store position information storage unit 707. Moreover, the action determination mechanism unit 103, on the basis of the distance from the current position of the robot 1 acquired by the position information acquisition unit 706 to the nearest store read from the store position information storage unit 707, outputs an action of the robot 1 to actuate an expressive motion leading to advertising promotion. Furthermore, the action determination mechanism unit 103 determines an expressive motion the robot 1 actuates in view of also the sound source of the keyword or the direction and distance to the target estimated by the direction/distance estimation unit 705.

The position information acquisition unit 706 acquires information of the current position of the robot 1, for example, on the basis of a detection signal of a position sensor such as a GPS sensor included in the external sensor unit 71. However, the position information acquisition unit 706 may acquire information of the current position of the robot 1 by using, instead of the position sensor, a simultaneous localization and mapping (SLAM) for performing self-position estimation using a laser range scanner, a camera, an encoder, a microphone array, or the like, or an alternative technology such as PlaceEngine that estimates the position by using a radio wave received from a wireless base station such as Wi-Fi (registered trademark).

The trigger/interest level correspondence table 702 shows the correspondence relationship between a combination of keywords and targets that are triggers for actuating an expressive motion leading to advertising promotion and interest levels assigned to the current position of the robot 1. For example, an advertiser such as a company that has a sponsor contract selects a combination of a keyword and a target that lead to advertising promotion, assigns an interest level to each combination of the keyword and the target, and sets it in the trigger/interest level correspondence table 702. For example, the trigger/interest level correspondence table 702 in the action determination mechanism unit 103 can be set or changed in setting from the outside via the communication unit 76.

Table 7 below shows an example of the trigger/interest level correspondence table 702. In the example shown in Table 7, a high interest level is assigned when the current position of the robot 1 is within a predetermined distance from the nearest store operated by an advertiser such as a company that has a sponsor contract.

TABLE 7

| | INTEREST |
|---|---|
| ACTION ACTUATION TRIGGER | LEVEL |
| VOICE RECOGNITION RESULT INCLUDES | 1 |
| “SNACK” OR “SWEETS” | |
| VOICE RECOGNITION RESULT INCLUDES | 2 |
| “ICE CREAM” | |
| VOICE RECOGNITION RESULT INCLUDES | 3 |
| BRAND NAME OF ADVERTISER | |
| IMAGE RECOGNITION RESULT INCLUDES | 4 |
| BRAND LOGO OF ADVERTISER | |
| VOICE RECOGNITION RESULT INCLUDES | 5 |
| BRAND NAME OF ADVERTISER AND IMAGE | |
| RECOGNITION RESULT INCLUDES BRAND LOGO | |
| DISTANCE FROM CURRENT POSITION TO | 6 |
| NEAREST STORE IS WITHIN 200 m | |

The store position information storage unit 707 stores position information of each store operated by an advertiser such as a company that has a sponsor contract.

When text data voice-recognized by the voice recognition unit 101A and a target image-recognized by the image recognition unit 101D are successively input, the trigger determination unit 701 checks which action actuation trigger listed in the trigger/interest level correspondence table 702 the combination of the text data and the target matches. Furthermore, the trigger determination unit 701 reads the position information of the store closest to the current position of the robot 1 acquired by the position information acquisition unit 706 from the store position information storage unit 707, and checks whether or not the distance from the current position of the robot 1 to the nearest store is listed in the trigger/interest level correspondence table 702 as an action actuation trigger. Then, in a case where the combination of the text data and the target matches any of the action actuation triggers, or in a case where the distance from the current position of the robot 1 to the nearest store becomes an action actuation trigger, the trigger determination unit 701 acquires the interest level assigned to the action actuation trigger from the corresponding entry of the trigger/interest level correspondence table 702 and outputs the interest level to the action determination unit 703 in the subsequent stage. Note that in a case where a plurality of action actuation triggers matches the input text data and target, the trigger determination unit 701 adopts the one with the highest interest level.

The direction/distance estimation unit 705 inputs voice data of a plurality of channels, which is the same as that input to the voice recognition unit 101A, and estimates the direction and distance of the sound source of the keyword (same as above). Furthermore, the direction/distance estimation unit 705 inputs the image recognition result obtained by recognizing the image of the stereo camera by the image recognition unit 101D, and estimates the direction and distance of the target (same as above).

The interest level/action correspondence table 704 shows the correspondence relationship between the distance from the current position of the robot 1 to the nearest store and the expressive motion leading to advertising promotion for each interest level. For example, the robot 1 having the interest level/action correspondence table 704 defined by the designer of the robot 1 set in advance is shipped. Of course, the advertiser or the like may be allowed to change the setting content of the interest level/action correspondence table 704 via the communication unit 76.

Table 8 below shows an example of the interest level/action correspondence table 704. In the example shown in Table 8, at the highest interest level, different expressive motions are defined depending on the distance from the current position of the robot 1 to the nearest store. In the case of 5 to 200 meters to the nearest store, an expressive motion that the robot 1 starts walking (i.e., tries to get closer) in the direction of the store is defined, in the case of 2 to 5 meters to the nearest store, an expressive motion that the robot 1 does not leave for a while from an area within a radius of 5 meters of the store (that is, does not leave the spot) is defined, and in the case of 2 meters or less to the nearest store, an expressive motion that the robot 1 jumps on the spot (i.e., indicates that the robot 1 is quite excited) is defined. The expressive motion such as approaching the store or not leaving the store also triggers the user to visit the store. It will be appreciated that all of the action contents listed in Table 8 are within the range of expressive motion that the robot 1 normally outputs, and it is possible to realize advertising promotion that the user hardly has a feeling of dislike and does not feel pushiness.

TABLE 8

| INTEREST | DISTANCE TO | |
|---|---|---|
| LEVEL | DESTINATION | ACTION CONTENT |
| 1 | — | RAISING EARS A LITTLE |
| 2 | — | ACTION OF 1 + WAGGING |
| | | TAIL SLOWLY |
| 3 | — | ACTION OF 1 + WAGGING |
| | | TAIL VIOLENTLY |
| 4 | — | ACTION OF 2 + SPINNING |
| | | IN CIRCLES ON THE SPOT |
| 5 | — | ACTION OF 2 + JUMPING |
| | | ON THE SPOT |
| 6 | LESS THAN 2 m TO | ACTION OF 3 + JUMPING |
| | NEAREST STORE | ON THE SPOT |
| | 2 TO 5 m TO | NOT LEAVING FROM AREA |
| | NEAREST STORE | WITHIN RADIUS OF 5 m |
| | | OF STORE |
| | 5 TO 200 m TO | STARTING WALKING |
| | NEAREST STORE | TOWARD STORE |

When the action determination unit 703 specifies the interest level of the trigger determined by the trigger determination unit 701 and an expressive motion corresponding to the distance from the current position of the robot 1 to the nearest store acquired by the position information acquisition unit 706 with reference to the interest level/action correspondence table 704, the action determination unit 703 determines an action of the robot 1 for actuating the expressive motion and outputs it to the posture transition mechanism unit 104, the voice synthesis unit 105, and the like.

For example, when the distance from the current position of the robot 1 to the nearest ice cream store is 150 meters, the trigger determination unit 701 determines that the interest level is “6” and outputs it to the action determination unit 703. The action determination unit 703 acquires the position information of the nearest store from the store position information storage unit 707 because the interest level is 6 and the distance to the nearest store is 5 to 200 meters, and actuates an action such as starting walking toward the store. Moreover, when reaching the area within a radius of 5 meters of the nearest store, the robot 1 does not try to leave the area for a while. The user follows the robot 1 who has started walking autonomously and is guided to the nearest store, which leads to advertising promotion of the ice cream store.

In the trigger/interest level correspondence table shown in Table 7 above, the highest interest level is assigned to the trigger that the distance from the current position of the robot 1 to the nearest store is within 200 meters. Therefore, an expressive motion is determined by giving priority to position information over the voice data and the image data input to the robot 1 (in other words, the sound source of the keyword and the information of the target). On the other hand, the trigger/interest level correspondence table can be individually defined for the voice data and the image data input to the robot 1 and the current position of the robot 1, and the trigger determination unit 701 gives priority to the voice data and the image data to perform trigger determination (alternatively, conversely, priority can be given to the current position of the robot 1 to perform trigger determination).

Table 9 below shows an example of a trigger/interest level correspondence table in which voice data and image data input to the robot 1 are used as action actuation triggers. Furthermore, Table 10 below shows an example of a trigger/interest level correspondence table in which the current position of the robot 1 is used as an action actuation trigger.

TABLE 9

| | INTEREST |
|---|---|
| ACTION ACTUATION TRIGGER | LEVEL |
| VOICE RECOGNITION RESULT INCLUDES | S1 |
| “SNACK” OR “SWEETS” | |
| VOICE RECOGNITION RESULT INCLUDES | S2 |
| “ICE CREAM” | |
| VOICE RECOGNITION RESULT INCLUDES | S3 |
| BRAND NAME OF ADVERTISER | |
| IMAGE RECOGNITION RESULT INCLUDES | S4 |
| BRAND LOGO OF ADVERTISER | |
| VOICE RECOGNITION RESULT INCLUDES | S5 |
| BRAND NAME OF ADVERTISER AND IMAGE | |
| RECOGNITION RESULT INCLUDES BRAND LOGO | |

TABLE 10

| DISTANCE FROM CURRENT | INTEREST |
|---|---|
| POSITION TO DESTINATION | LEVEL |
| LESS THAN 2 m TO NEAREST STORE | L1 |
| 2 TO 5 m TO NEAREST STORE | L2 |
| 5 TO 200 m TO NEAREST STORE | L3 |

Furthermore, in a case where the trigger/interest level correspondence table is individually defined in which the voice data and the image data are given priority over the current position of the robot 1 as the action actuation trigger as described above, the interest level/action correspondence table also needs to define expressive motions corresponding to all the interest levels S1 to S5 and L1 to L3 determined by each trigger/interest level correspondence table as shown in Table 11 below. It will be appreciated that all of the action contents listed in Table 11 are within the range of expressive motion that the robot 1 normally outputs, and it is possible to realize advertising promotion that the user hardly has a feeling of dislike and does not feel pushiness.

TABLE 11

| INTEREST | DISTANCE TO | |
|---|---|---|
| LEVEL | DESTINATION | ACTION CONTENT |
| S1 | — | RAISING EARS A LITTLE |
| S2 | — | ACTION OF 1 + WAGGING |
| | | TAIL SLOWLY |
| S3 | — | ACTION OF 1 + WAGGING |
| | | TAILVIOLENTLY |
| S4 | — | ACTION OF 2 + SPINNING |
| | | IN CIRCLES ON THE SPOT |
| S5 | — | ACTION OF 2 + JUMPING |
| | | ON THE SPOT |
| L1 | LESS THAN 2 m TO | ACTION OF 3 + JUMPING |
| | NEAREST STORE | ON THE SPOT |
| L2 | 2 TO 5 m TO | NOT LEAVING FROM AREA |
| | NEAREST STORE | WITHINRADIUS OF 5 m |
| | | OF STORE |
| L3 | 5 TO 200 m TO | STARTING WALKING |
| | NEAREST STORE | TOWARD STORE |

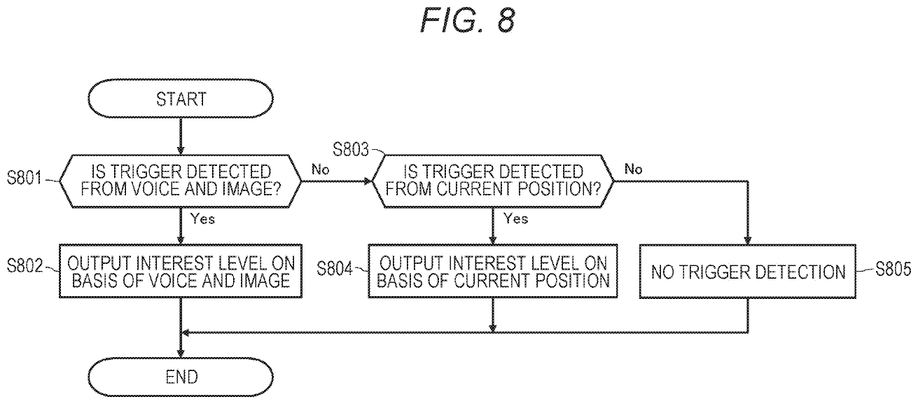

FIG. 8 shows, in the form of a flowchart, an example of a processing procedure for the trigger determination unit 701 to perform trigger determination by giving priority to the voice data and the image data using trigger/interest level correspondence tables that are individually defined for the voice data and the image data input to the robot 1 and the current position of the robot 1.

When text data voice-recognized by the voice recognition unit 101A and a target image-recognized by the image recognition unit 101D are input, the trigger determination unit 701 attempts to detect an action actuation trigger by referring to a trigger/interest level correspondence table in which the voice data and the image data are action actuation triggers shown in Table 9 (step S801).

Then, in a case where the action actuation trigger has been detected from at least one of the voice recognition result or the image recognition result (Yes in step S801), the trigger determination unit 701 reads and outputs the interest level corresponding to the voice recognition result and the image recognition result from the trigger/interest level correspondence table shown in Table 9 (step S802).

On the other hand, in a case where an action actuation trigger cannot be detected from either the voice recognition result or the image recognition result (No in step S801), the trigger determination unit 701 then attempts to detect an action actuation trigger by referring to the trigger/interest level correspondence table in which the current position of the robot 1 is an action actuation trigger shown in FIG. 10 (step S803).

Then, in a case where the action actuation trigger has been detected from the current position of the robot 1 (Yes in step S803), the trigger determination unit 701 reads and outputs the interest level corresponding to the current position of the robot 1 from the trigger/interest level correspondence table shown in Table 10 (step S804).

Furthermore, in a case where an action actuation trigger cannot be detected from any of the voice recognition result, the image recognition result, and the current position of the robot (No in step S803), the trigger determination unit 701 outputs a result that the trigger is not detected (step S805), and ends the present processing.

Thereafter, when the action determination unit 703 specifies the interest level of the trigger determined by the trigger determination unit 701 or an expressive motion corresponding to the distance from the current position of the robot 1 to the nearest store acquired by the position information acquisition unit 706 with reference to the interest level/action correspondence table shown in Table 11, the action determination unit 703 determines an action of the robot 1 for actuating the expressive motion and outputs it to the posture transition mechanism unit 104, the voice synthesis unit 105, and the like.

In a case where the trigger determination unit 701 uses the trigger/interest level correspondence tables shown in Tables 9 and 10, and the action determination unit 703 performs the trigger determination by giving priority to the voice data and the image data according to the processing procedure shown in FIG. 8, when a trigger based on the voice data and the image data such as a trigger keyword such as “snack”, “sweets”, and “ice cream” or a target such as a logo of an ice cream store is input, the expressive motion of the robot 1 according to the determined interest level is actuated regardless of the distance from the current position of the robot 1 to the nearest store. Furthermore, in a case where the trigger is not detected from the input voice data and image data, the expressive motion of the robot 1 according to the interest level determined on the basis of the distance from the current position of the robot 1 to the nearest store is actuated.

### B-7. Configuration Example 5

In each of the configuration examples 1 to 4 described above, an expressive motion the robot 1 actuates on the basis of the trigger detected on the basis of the voice recognition result, the image recognition result, and the like is the same regardless of who the robot 1 is interacting with. However, even when the robot 1 takes the same action, it is assumed that the effect of the obtained advertising promotion is different for each user (or profile of each user). For example, some users prefer a vigorous expressive motion, while other users prefer an expressive motion of being suppressed to some extent.

Therefore, by utilizing the user identification function provided in the voice recognition unit 101A and the image recognition unit 101D, the information of the user whom the robot 1 is interacting with may be further utilized to actuate an expressive motion leading to advertising promotion.

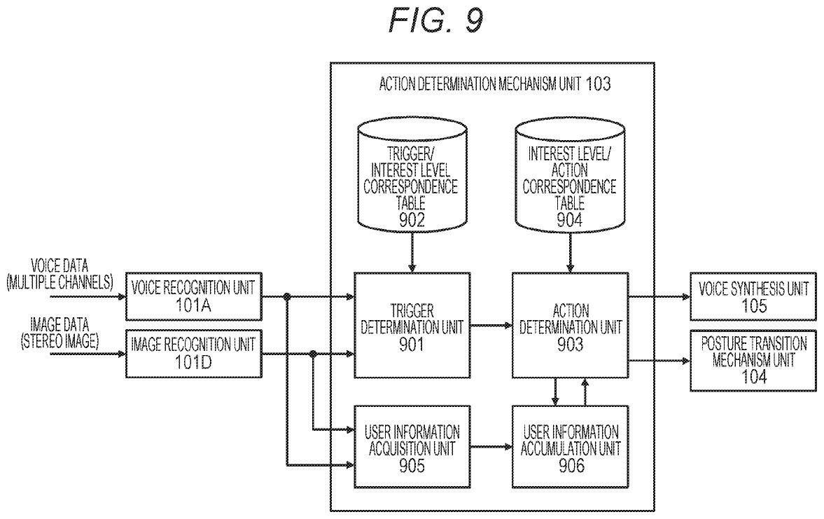

FIG. 9 shows a functional configuration example of the action determination mechanism unit 103 for the robot 1 to actuate an expressive motion leading to advertising promotion using the information of the user whom the robot 1 is interacting with.

The illustrated action determination mechanism unit 103 includes a trigger determination unit 901, a trigger/interest level correspondence table 902, an action determination unit 903, an interest level/action correspondence table 904, a user information acquisition unit 905, and a user information accumulation unit 906. Moreover, the action determination mechanism unit 103 uses the profile of the user acquired by the user information acquisition unit 905 and the past information of the user accumulated in the user information accumulation unit 906 to output an action of the robot 1 for actuating an expressive motion leading to advertising promotion.

First, a motion example of the action determination mechanism unit 103 when actuating an expressive motion that leads to advertising promotion using the profile information of a user will be described.

The trigger determination unit 901 extracts a keyword that leads to advertising promotion on the basis of the voice recognition result, and extracts a target that leads to advertising promotion on the basis of the image recognition result. The trigger/interest level correspondence table 902 shows the correspondence relationship between a combination of keywords and targets that are triggers for actuating an expressive motion leading to advertising promotion and interest levels assigned to each combination of the keywords and the targets. For example, an advertiser such as a company that has a sponsor contract selects a combination of a keyword and a target that lead to advertising promotion, assigns an interest level to each combination of the keyword and the target, and sets it in the trigger/interest level correspondence table 902. For example, the trigger/interest level correspondence table 902 in the action determination mechanism unit 103 can be set or changed in setting from the outside via the communication unit 76. The same trigger/interest level correspondence table 902 as in Table 5 above may be used.

When text data voice-recognized by the voice recognition unit 101A and a target image-recognized by the image recognition unit 101D are successively input, the trigger determination unit 901 checks which action actuation trigger listed in the trigger/interest level correspondence table 902 the combination of the text data and the target matches. Then, when the combination of the text data and the target matches any of the action actuation triggers, the trigger determination unit 901 acquires the interest level assigned to the action actuation trigger from the corresponding entry of the trigger/interest level correspondence table 902 and outputs the interest level to the action determination unit 903 in the subsequent stage. Note that in a case where a plurality of action actuation triggers matches the input text data and target, the trigger determination unit 901 adopts the one with the highest interest level.

The user information acquisition unit 905 acquires information of the user identified by the voice recognition unit 101A or the image recognition unit 101D on the basis of the voice recognition result or the image recognition result by the user identification function. For example, on the basis of the voice recognition result and the image recognition result, profile information such as the age and sex of the user is also acquired in addition to performing individual identification. Of course, the user information acquisition unit 905 may acquire information of the user using a user identification function other than voice recognition or image recognition. Then, the user information acquisition unit 905 assigns a user ID to each user and outputs profile information of the user to the user information accumulation unit 906.

The user information accumulation unit 906 accumulates the profile information for each user acquired by the user information acquisition unit 905 in association with the user ID. Note that the information associated with the reaction of the user can be acquired on the basis of the image recognition result and the voice recognition result at the time when the robot 1 actuates the expressive motion. Table 12 below shows an example of profile information for each user accumulated in the user information accumulation unit 906. In the example shown in Table 12, only two types of parameters “age” and “sex” are used as the profile information of the user, but other parameters such as “hometown” and “occupation” and three or more types of parameters may be used.

TABLE 12

| ID | AGE | SEX |
|---|---|---|
| 0 | 40S | MALE |
| 1 | 10S | FEMALE |
| 2 | 40S | FEMALE |

The interest level/action correspondence table 904 shows the correspondence relationship between the profile of the user and the expressive motion of the robot 1 leading to advertising promotion for each interest level. For example, the robot 1 having the interest level/action correspondence table 904 defined by the designer of the robot 1 set in advance is shipped. Of course, the advertiser or the like may be allowed to change the setting content of the interest level/action correspondence table 604 via the communication unit 76.

Table 13 below shows an example of the interest level/action correspondence table 904. In Table 13, the expressive motions of the robot 1 according to the age of the user are defined as the profile of the user. That is, at the interest level 4 or above, different expressive motions are defined depending on whether the age of the user is 20s or younger and 30s or older. Of course, it is also possible to use parameters of profile information other than “age”, such as “sex”, to define different expressive motions for each parameter value for the same interest level. It will be appreciated that all of the action contents listed in Table 13 are within the range of expressive motion that the robot 1 normally outputs, and it is possible to realize advertising promotion that the user hardly has a feeling of dislike and does not feel pushiness.

TABLE 13

| INTEREST | USER'S | |
|---|---|---|
| LEVEL | AGE | ACTION CONTENT |
| 1 | — | RAISING EARS A LITTLE |
| 2 | — | ACTION OF 1 + WAGGING TAIL |
| | | SLOWLY |
| 3 | — | ACTION OF 1 + WAGGING TAIL |
| | | VIOLENTLY |
| 4 | 20S | ACTION OF 2 + SPINNING IN |
| | | CIRCLES JUST THREE TIMES ON |
| | | THE SPOT |
| | 30S | ACTION OF 2 + SPINNING IN |
| | | CIRCLES JUST ONE TIME ON |
| | | THE SPOT |
| 5 | 20S | ACTION OF 3 + JUMPING |
| | | THREE TIMES ON THE SPOT |
| | 30S | ACTION OF 3 + JUMPING |
| | | ONE TIME ON THE SPOT |

When the action determination unit 903, after acquiring the profile information of the user whom the robot 1 is interacting with from the user information accumulation unit 906, specifies the interest level of the trigger determined by the trigger determination unit 601 and an expressive motion corresponding to the profile information of the user with reference to the interest level/action correspondence table 904, the action determination unit 903 determines an action of the robot 1 for actuating the expressive motion and outputs it to the posture transition mechanism unit 104, the voice synthesis unit 105, and the like.

For example, it is assumed that an ice cream store, which is an advertiser, wants to strongly advertise to 10s to 20s. Then, it is assumed that a teenage woman uttered, “oo ice cream looks delicious!” while showing the robot 1 an advertisement with the brand logo of the ice cream store printed on it. At this time, the trigger determination unit 901 determines the interest level “5” from Table 5 above, and the user information acquisition unit 905 outputs “1” as the user ID of the speaker from the user recognition result. The user information accumulation unit 906 outputs profile information including that the age of the user having the user ID “1” is in 10s to the action determination unit 903. The action determination unit 903 refers to Table 13 above in view of the fact that the determined interest level of the trigger is “5” and the information that the age of the user in interaction is in 10s, and selects an expressive motion of the robot 1 that the robot 1 raises the ears a little, wags the tail 4 violently, and jumps three times on the spot. By using the user identification function as described above, the action of the robot 1 can be changed according to the profile of the user, and the action having a high advertising promotion effect can be actuated by the robot 1 for each user.

Next, a motion example of the action determination mechanism unit 103 when actuating an expressive motion that leads to advertising promotion using past information of a user will be described.

The trigger/interest level correspondence table 902 shows the correspondence relationship between a combination of keywords and targets that are triggers for actuating an expressive motion leading to advertising promotion and interest levels assigned to each combination of the keywords and the targets. The same trigger/interest level correspondence table 902 as in Table 5 above may be used.

When text data voice-recognized by the voice recognition unit 101A and a target image-recognized by the image recognition unit 101D are successively input, the trigger determination unit 901 checks which action actuation trigger listed in the trigger/interest level correspondence table 902 the combination of the text data and the target matches. Then, when the combination of the text data and the target matches any of the action actuation triggers, the trigger determination unit 901 acquires the interest level assigned to the action actuation trigger from the corresponding entry of the trigger/interest level correspondence table 902 and outputs the interest level to the action determination unit 903 in the subsequent stage.

The user information acquisition unit 905 acquires information of the user identified by the voice recognition unit 101A or the image recognition unit 101D on the basis of the voice recognition result or the image recognition result by the user identification function, and profile information. Then, the user information acquisition unit 905 assigns a user ID to each user and outputs the profile information of the user to the user information accumulation unit 906 (same as above).

The user information accumulation unit 906 accumulates the profile information for each user acquired by the user information acquisition unit 905 in association with the user ID. Furthermore, for example, the reaction of the user when the robot 1 actuates the expressive motion determined by the action determination unit 903 is also accumulated as the past information of the user in association with the user ID. Note that the information associated with the reaction of the user can be acquired on the basis of the image recognition result and the voice recognition result at the time when the robot 1 actuates the expressive motion. Table 14 below shows an example of past information for each user accumulated in the user information accumulation unit 906. In the example shown in Table 14, the reaction of the user to each expressive motion actuated by the robot 1 is evaluated in two stages: “Positive” and “Negative”. However, it may be evaluated in three or more stages. Alternatively, the reaction of the user may be evaluated in other formats, such as whether or not the user has purchased or used an advertised and promoted product or service.

TABLE 14

| | | | PAST REACTION TO |
|---|---|---|---|
| ID | AGE | SEX | EXPRESSIVE MOTION |
| 0 | 40S | MALE | Negative |
| 1 | 10S | FEMALE | Positive |
| 2 | 40S | FEMALE | Positive |

The interest level/action correspondence table 904 shows the correspondence relationship between the past information of the user and the expressive motion of the robot 1 leading to advertising promotion for each interest level. For example, the robot 1 having the interest level/action correspondence table 904 defined by the designer of the robot 1 set in advance is shipped. Of course, the advertiser or the like may be allowed to change the setting content of the interest level/action correspondence table 604 via the communication unit 76.

Table 15 below shows an example of the interest level/action correspondence table 904. In Table 15, the expressive motions of the robot 1 are defined for each interest level and are controlled whether or not to be actuated according to the past reaction of the user to the expressive motions. That is, the expressive motion with respect to which the past reaction of the user is Positive is repeatedly actuated, but actuation of the expressive motion with respect to which the past reaction of the user is Negative is suppressed. Of course, the expressive motion with respect to which the past reaction of the user is Positive may be increased, or the expressive motion with respect to which the past reaction of the user is Negative may be replaced with another expressive motion. It will be appreciated that all of the action contents listed in Table 15 are within the range of expressive motion that the robot 1 normally outputs, and it is possible to realize advertising promotion that the user hardly has a feeling of dislike and does not feel pushiness.

TABLE 15

| INTEREST | PAST | |
|---|---|---|
| LEVEL | REACTION | ACTION CONTENT |
| 1 | — | RAISING EARS A LITTLE |
| 2 | — | ACTION OF 1 + WAGGING |
| | | TAIL SLOWLY |
| 3 | — | ACTION OF 1 + WAGGING |
| | | TAIL VIOLENTLY |
| 4 | Positive | ACTION OF 2 + SPINNING |
| | | IN CIRCLES JUST ONE TIME |
| | | ON THE SPOT |
| | Negative | NOT ACTUATING |
| | | EXPRESSIVE MOTION |
| 5 | Positive | ACTION OF 3 + JUMPING |
| | | ONE TIME ON THE SPOT |
| | Negative | NOT ACTUATING |
| | | EXPRESSIVE MOTION |

When the action determination unit 903, after acquiring the past information of the user whom the robot 1 is interacting with from the user information accumulation unit 906, specifies the interest level of the trigger determined by the trigger determination unit 601 and an expressive motion corresponding to the past information of the user with reference to the interest level/action correspondence table 904, the action determination unit 903 determines an action of the robot 1 for actuating the expressive motion and outputs it to the posture transition mechanism unit 104, the voice synthesis unit 105, and the like.

The user information accumulation unit 906 accumulates the reaction of the user at the time when the robot 1 actuated an expressive motion leading to advertising promotion in the past. The reaction of the user mentioned here includes a “Positive” reaction such as laughing or uttering a trigger word many times, and a “Negative” reaction such as making a disgruntled face and utterance of stopping an expressive motion of the robot 1 such as “Stop”. The user information acquisition unit 905 acquires user information indicating whether the reaction of the user is “Positive” or “Negative” on the basis of the voice recognition result by the voice recognition unit 101A and the image recognition result by the image recognition unit 101D, and accumulates the user information in the user information accumulation unit 906. Then, the action determination unit 903 uses the information associated with the past reactions accumulated for each user at a frequency of causing the robot 1 to actuate the expressive motion leading to advertising promotion.

For example, in a case where the robot 1 detects that a male user in his 40s holds an advertisement printed with the brand logo of an ice cream store in his hand, the trigger determination unit 901 refers to Table 5 above and determines that the interest level is “4”. Furthermore, the user information acquisition unit 905 specifies that the user ID is “0” according to the user identification result based on the voice recognition or the image recognition, and outputs it to the user information accumulation unit 906. Then, when the action determination unit 903 acquires the information that the past reaction of the user with the user ID “0” was “Negative” from the user information accumulation unit 906, the action determination unit 903 refers to the interest level/action correspondence table shown in Table 15 above, and determines that the robot 1 does not actuate an expressive motion leading to advertising promotion. In this way, in a case where the user has a feeling of discomfort, it is possible to reduce the frequency of actuating an expressive motion leading to advertising promotion so as to prevent the advertising promotion from being counterproductive.

### C. Application Example

In the above description, the dog-shaped robot 1 is taken as an example of the interactive apparatus that actuates an expressive motion leading to advertising promotion, but the interactive apparatus is not limited to the robot. The technology disclosed in the present specification can be applied to various types of information devices having a function of interacting with a user, such as a car navigation system installed in a passenger car and a map application installed in a multifunctional information terminal such as a smartphone. For example, when a plurality of routes with the same arrival time is proposed at the time of route searching including navigation that passes in front of the advertiser's store, the user will not have a feeling of dislike and advertising promotion can be naturally realized.

Furthermore, in the configuration examples shown in FIGS. 4 to 7 and 9, the trigger for actuating the expressive motion leading to advertising promotion is mainly detected from the voice data or the image data, but the trigger may be detected using various information other than the voice and the image indicating the state of the interactive apparatus or the user, and the interest level may be assigned to the trigger other than the voice and the image.

For example, the trigger for actuating the expressive motion leading to advertising promotion may be determined by using the action of the user (including action history), clothes of the user, position information of the user, time zone, and interactive apparatus or surrounding environments of the user (temperature, humidity, weather, smell, noise, etc.). It is not necessary for the interactive apparatus such as the robot 1 to directly sense this kind of information, but the interactive apparatus may be paired with a device such as a smartphone or a wearable device that the user carries or wears to acquire information used for determination of the trigger from the device of this kind.

Furthermore, the interactive apparatus may use information obtained from the paired device for advertisement targeting. Therefore, it becomes possible to effectively carry out advertising promotion according to the age group and lifestyle of the user. For example, a sports drink can be advertised to a user who often jogs.

Furthermore, the interactive apparatus may actively try to detect the trigger instead of waiting for actuation of an expressive motion until a predetermined trigger is detected. For example, in the case of an interactive apparatus equipped with moving means such as the legged robot 1 shown in FIG. 1, the interactive apparatus may approach a television that is turned on to wait for a commercial image, which is a trigger, or search an advertisement, which is a target, from newspaper placed on the floor.

Furthermore, in the above, an embodiment has been described in which the interactive apparatus actuates an expressive motion leading to advertising promotion, but it can be applied to the actuation of an expressive motion for purposes other than advertising promotion. For example, the technology disclosed in the present specification can also be used for action change of a user such as improvement of lifestyle habits. The interactive apparatus determines a trigger including a keyword or a target that reminds improvement of lifestyle habits such as being happy by responding to the word “walking,” being restless when it is time to go for a walk, and being happy when the user picks up a jacket that the user wears during a walk, and actuates an expressive motion that prompts the user to take actions for improving lifestyle habits.

Furthermore, in the above, an embodiment has been described in which one interactive apparatus (such as one robot) actuates an expressive motion leading to a predetermined purpose alone, but an application example in which a plurality of interactive apparatuses cooperates to actuate an expressive motion leading to one purpose is also possible. For example, when a robot detects a keyword or a target serving as a trigger, the information is transferred to another robot together with its own position. When the other robot determines that the received information of the trigger matches its own trigger, it moves to the position of the transmission source robot and appropriately actuates an expressive motion. Furthermore, not only the same robots but also different kinds of interactive apparatuses such as a robot and a voice agent can be linked to each other to actuate an expressive motion leading to one purpose.

Furthermore, in the above, the embodiment has been described in which the interactive apparatus actuates an expressive motion leading to a predetermined purpose using detection of a predetermined keyword or target as a trigger. However, conversely, an application example of actuating an action corresponding to a change in detection information such as actuating an expressive motion that leads to a predetermined purpose using a sudden disappearance of an existing keyword or target as a trigger is also possible. For example, when a commercial image of an ice cream store on a television is over (or the television is turned off) and the brand logo of the ice cream store disappears, the robot 1 actuates an action of expressing sadness. Then, the user is aware of the importance of the ice cream store, which leads to advertising promotion of the ice cream store.

Furthermore, the above description describes that when the interactive apparatus such as the robot 1 detects a plurality of action actuation triggers simultaneously, the interactive apparatus adopts an action actuation trigger having the highest interest level. As a variation thereof, any one of simultaneously detected action actuation triggers may be randomly adopted, another action (for example, the robot 1 roars) may be actuated without adopting any action actuation trigger, or an action actuation trigger that has not been detected in the past is adopted and an expressive motion that has not been used so far is preferentially actuated.

Furthermore, in the above, the movement using the four limbs of the robot 1 and the expressive motion using the drive of the ears and the neck have been taken as an example, but advertising promotion may be performed within the range of an ordinary expressive motion using an output function the interactive apparatus includes or can use. For example, a motion can be expressed using information of sounds other than languages such as utterance, barking, and squeaking, or a motion can be expressed using visual information such as an image displayed on the display and facial expressions of eyes and faces.

### D. Summary

According to the technology disclosed in the present specification, the interactive apparatus such as a robot or a voice agent performs advertising promotion in the form of indicating a reaction to a product or service targeted for the advertising promotion within the range of expressive motions that are normally output. Accordingly, the expressive motion for advertising promotion can realize an advertising promotion the user does not feel pushy without disturbing the interaction between the user and the interactive apparatus.

For example, in a case where the dog-shaped robot 1 performs advertising promotion, the robot 1 actuates an expressive motion of, for example, being happy when hearing a specific keyword, and when finding a target while acting with the user, actively approaching the target and not leaving the target, which leads to advertising promotion. Such an expressive motion has an aspect that it leads to advertising promotion, but it is an imitation of an actual action of dogs. Accordingly, the user does not have a feeling of pushiness by the advertising promotion, but interprets the action as personality of the autonomously operating robot 1. Furthermore, as compared to the method of suddenly presenting advertisement information during an interaction with the user, the robot 1 can naturally realize advertising promotion without the user having a feeling of dislike.

Each time the interactive apparatus, such as a robot or a voice agent, to which the technology disclosed in the present specification is applied, interacts with the user, the frequency with which the user contacts an advertisement target increases, and it can be expected that a large advertising promotion effect can be obtained.

According to the technology disclosed in the present specification, the interactive apparatus performs advertising promotion within the range of expressive motions that are normally output. In other words, it is not necessary to present an advertisement that matches the interests or concerns of the user. Therefore, it is possible to perform advertising promotion even in the situation where sufficient user information is not accumulated or even in the case of an advertisement the content of which is slightly off the interest of the user.

### INDUSTRIAL APPLICABILITY

The technology disclosed in the present specification has been described in detail with reference to the specific embodiments. However, it is obvious that those skilled in the art can modify or substitute the embodiments without departing from the gist of the technology disclosed in the present specification.

In the present specification, the embodiments in which the technology disclosed in the present specification is applied to a legged robot have been mainly described, but the gist of the technology disclosed in the present specification is not limited thereto. The technology disclosed in the present specification can be similarly applied to various types of interactive apparatuses such as mobile robots other than legged mobile robots, non-mobile interactive robots, voice agents, and the like, to obtain an advertising promotion effect by a method that is natural and the user hardly has a feeling of dislike.

With the technology disclosed in the present specification, the modality used to perform advertising promotion is not particularly limited. For example, in the case of an interactive apparatus without a display, information associated with advertising promotion may be inserted during a voice interaction, or information associated with advertising promotion may be output using a paired information terminal such as a smartphone. Furthermore, in the case of a robot that cannot take interaction in a language, it may utter an action related to advertising promotion using gestures or movement means or output information associated with advertising promotion by using a paired information terminal such as a smartphone.

In short, although the technology disclosed in the present specification has been described by way of example, the content described in the present specification should not be interpreted in a limited manner. In order to determine the gist of the technology disclosed in the present specification, the claims should be considered.

Note that the technology disclosed in the present specification may have the following configurations.

(1) An information processing apparatus including:
a determination unit that determines that a trigger according to which an interactive apparatus should actuate an expressive motion leading to advertising promotion has been generated; and
a decision unit that decides an expressive motion of the interactive apparatus on the basis of the determined trigger.

(2) The information processing apparatus according to (1), in which
the determination unit determines an interest level indicated by the trigger, and
the decision unit decides an expressive motion of the interactive apparatus according to the interest level.

(3) The information processing apparatus according to (1) or (2), in which
the determination unit detects a trigger on the basis of a recognition result of a detection signal of a sensor that detects a state of surroundings of the interactive apparatus.

(4) The information processing apparatus according to any of (1) to (3), in which
the determination unit determines a trigger on the basis of a recognition result of at least one or both of voice information and image information of surroundings of the interactive apparatus.

(5) The information processing apparatus according to (4), in which
the determination unit detects, as a trigger, that a predetermined keyword has been uttered on the basis of the voice recognition result.

(6) The information processing apparatus according to (4) or (5), in which
the determination unit detects, as a trigger, that a predetermined target has been expressed on the basis of the image recognition result.

(7) The information processing apparatus according to any of (1) to (6), in which
the interactive apparatus includes a self-propelled function, and
the decision unit decides an expressive motion of the interactive apparatus including a movement of the interactive apparatus.

(8) The information processing apparatus according to any of (1) to (7), in which
the interactive apparatus includes a self-propelled function,
the information processing apparatus further includes an estimation unit that estimates a direction or distance of the trigger detected by the determination unit, and
the decision unit decides an expressive motion including a movement of the interactive apparatus according to the direction or distance of the trigger.

(9) The information processing apparatus according to (8), in which
the determination unit determines an interest level indicated by the trigger, and
the decision unit decides an expressive motion including a motion that the interactive apparatus approaches the trigger when the interest level is high.

(10) The information processing apparatus according to any of (1) to (9), further including
a position information acquisition unit that acquires position information of the interactive apparatus, in which
the determination unit determines the trigger in consideration of a current position of the interactive apparatus, or
the decision unit decides an expressive motion of the interactive apparatus in consideration of the current position of the interactive apparatus.

(11) The information processing apparatus according to any of (1) to (10), in which
the determination unit determines the trigger on the basis of a distance from a current position of the interactive apparatus to a predetermined destination, or
the decision unit decides an expressive motion of the interactive apparatus on the basis of the distance from the current position of the interactive apparatus to the predetermined destination.

(12) The information processing apparatus according to (11), in which
the interactive apparatus includes a self-propelled function, and
the decision unit decides an expressive motion including a movement of the interactive apparatus within a predetermined distance from the current position of the interactive apparatus to the destination.

(13) The information processing apparatus according to (11) or (12), in which
the determination unit determines an interest level indicated by the trigger, and
when the interest level is high, the decision unit decides an expressive motion including presence or absence of the movement of the interactive apparatus according to the distance from the current position of the interactive apparatus to the predetermined destination.

(14) The information processing apparatus according to any of (10) to (13), in which
the determination unit determines the trigger using a recognition result of a detection signal of a sensor that detects a state of surroundings of the interactive apparatus in preference to the position information acquired by the position information acquisition unit.

(15) The information processing apparatus according to any of (1) to (14), in which
the recognition unit further recognizes a user information acquisition unit that acquires information of a user who interacts with the interactive apparatus, and
the decision unit decides an expressive motion of the interactive apparatus using the information of the user.

(16) The information processing apparatus according to (15), in which
the decision unit decides an expressive motion of the interactive apparatus using profile information of the user.

(17) The information processing apparatus according to (15) or (16), in which
the decision unit decides an expressive motion of the interactive apparatus in this time on the basis of a reaction of the user with respect to an expressive motion actuated by the interactive apparatus in a past.

(18) The information processing apparatus according to (1), further including
the interactive apparatus.

(19) An information processing method including:
a determination step of determining that a trigger according to which an interactive apparatus should actuate an expressive motion leading to advertising promotion has been generated; and
a decision step of deciding an expressive motion of the interactive apparatus on the basis of the determined trigger.

(20) A robot apparatus including:
a sensor;
a drive unit or an output unit;
a recognition unit that recognizes a state of surroundings on the basis of a detection result of the sensor; and
a decision unit that decides an expressive motion leading to advertising promotion using the drive unit or the output unit on the basis of the state recognized by the recognition unit.

### REFERENCE SIGNS LIST

1 Robot
2 Trunk unit
3 Head unit
4 Tail
6 Leg unit
7 Neck joint
8 Tail joint
9 Thigh unit
10 Shin unit
11 Hip joint
12 Knee joint
13 Foot unit
51 Touch sensor
55 Display unit
61 Main control unit
63 Sub-control unit
71 External sensor unit
72 Speaker
73 Internal sensor unit
74 Battery
75 External memory unit
76 Communication unit
81L/R Camera
82 Microphone
91 Battery sensor
92 Acceleration sensor
101 State recognition information processing unit
101A Voice recognition unit
101a Control unit
101b Speaker identification unit
101C Pressure processing unit
101D Image recognition unit
102 Model storage unit
103 Action determination mechanism unit
104 Posture transition mechanism unit
105 Voice synthesis unit
401 Trigger determination unit
402 Trigger/interest level correspondence table
403 Action determination unit
404 Interest level/action correspondence table
501 Trigger determination unit
502 Trigger/interest level correspondence table
503 Action determination unit
504 Interest level/action correspondence table
601 Trigger determination unit
602 Trigger/interest level correspondence table
603 Action determination unit
604 Interest level/action correspondence table
605 Direction/distance estimation unit
701 Trigger determination unit
702 Trigger/interest level correspondence table
703 Action determination unit
704 Interest level/action correspondence table
705 Direction/distance estimation unit
706 Position information acquisition unit
707 Store position information storage unit
901 Trigger determination unit
902 Trigger/interest level correspondence table
903 Action determination unit
904 Interest level/action correspondence table
905 User information acquisition unit
906 User information accumulation unit

1. An information processing apparatus comprising:
a determination unit that determines that a trigger according to which an interactive apparatus should actuate an expressive motion leading to advertising promotion has been generated; and
a decision unit that decides an expressive motion of the interactive apparatus on a basis of the determined trigger.

2. The information processing apparatus according to claim 1, wherein
the determination unit determines an interest level indicated by the trigger, and
the decision unit decides an expressive motion of the interactive apparatus according to the interest level.

3. The information processing apparatus according to claim 1, wherein
the determination unit detects a trigger on a basis of a recognition result of a detection signal of a sensor that detects a state of surroundings of the interactive apparatus.

4. The information processing apparatus according to claim 1, wherein
the determination unit determines a trigger on a basis of a recognition result of at least one or both of voice information and image information of surroundings of the interactive apparatus.

5. The information processing apparatus according to claim 4, wherein
the determination unit detects, as a trigger, that a predetermined keyword has been uttered on a basis of the voice recognition result.

6. The information processing apparatus according to claim 4, wherein
the determination unit detects, as a trigger, that a predetermined target has been expressed on a basis of the image recognition result.

7. The information processing apparatus according to claim 1, wherein
the interactive apparatus includes a self-propelled function, and
the decision unit decides an expressive motion of the interactive apparatus including a movement of the interactive apparatus.

8. The information processing apparatus according to claim 1, wherein
the interactive apparatus includes a self-propelled function,
the information processing apparatus further includes an estimation unit that estimates a direction or distance of the trigger detected by the determination unit, and
the decision unit decides an expressive motion including a movement of the interactive apparatus according to the direction or distance of the trigger.

9. The information processing apparatus according to claim 8, wherein
the determination unit determines an interest level indicated by the trigger, and
the decision unit decides an expressive motion including a motion that the interactive apparatus approaches the trigger when the interest level is high.

10. The information processing apparatus according to claim 1, further comprising
a position information acquisition unit that acquires position information of the interactive apparatus, wherein
the determination unit determines the trigger in consideration of a current position of the interactive apparatus, or the decision unit decides an expressive motion of the interactive apparatus in consideration of the current position of the interactive apparatus.

11. The information processing apparatus according to claim 1, wherein
the determination unit determines the trigger on a basis of a distance from a current position of the interactive apparatus to a predetermined destination, or the decision unit decides an expressive motion of the interactive apparatus on a basis of the distance from the current position of the interactive apparatus to the predetermined destination.

12. The information processing apparatus according to claim 11, wherein
the interactive apparatus includes a self-propelled function, and
the decision unit decides an expressive motion including a movement of the interactive apparatus within a predetermined distance from the current position of the interactive apparatus to the destination.

13. The information processing apparatus according to claim 11, wherein
the determination unit determines an interest level indicated by the trigger, and
when the interest level is high, the decision unit decides an expressive motion including presence or absence of a movement of the interactive apparatus according to the distance from the current position of the interactive apparatus to the predetermined destination.

14. The information processing apparatus according to claim 10, wherein
the determination unit determines the trigger using a recognition result of a detection signal of a sensor that detects a state of surroundings of the interactive apparatus in preference to the position information acquired by the position information acquisition unit.

15. The information processing apparatus according to claim 1, wherein
the recognition unit further recognizes a user information acquisition unit that acquires information of a user who interacts with the interactive apparatus, and
the decision unit decides an expressive motion of the interactive apparatus using the information of the user.

16. The information processing apparatus according to claim 15, wherein
the decision unit decides an expressive motion of the interactive apparatus using profile information of the user.

17. The information processing apparatus according to claim 15, wherein
the decision unit decides an expressive motion of the interactive apparatus in this time on a basis of a reaction of the user with respect to an expressive motion actuated by the interactive apparatus in a past.

18. The information processing apparatus according to claim 1, further comprising
the interactive apparatus.

19. An information processing method comprising:
a determination step of determining that a trigger according to which an interactive apparatus should actuate an expressive motion leading to advertising promotion has been generated; and
a decision step of deciding an expressive motion of the interactive apparatus on a basis of the determined trigger.

20. A robot apparatus comprising:
a sensor;
a drive unit or an output unit;
a recognition unit that recognizes a state of surroundings on a basis of a detection result of the sensor; and
a decision unit that decides an expressive motion leading to advertising promotion using the drive unit or the output unit on a basis of the state recognized by the recognition unit.
